(19) United States
(12) Patent Application Publication
(10) Pub. No.: US 2008/0077376 A1
(43) Pub. Date: Mar. 27, 2008

(54) Apparatus and method for the determination of SEU and SET disruptions in a circuit caused by ionizing particle strikes

(75) Inventors: Hafnaoui Belhaddad, Fontaine (FR); Renaud Perez, Grenoble (FR)

Correspondence Address: BASINSKI & ASSOCIATES, 113 SAN NICOLAS AVENUE, SANTA BARBARA, CA, 93109, US

(73) Assignee: iROC Technologies, Grenoble (FR)

(21) Appl. No.: 11/807,433

(22) Filed: May 29, 2007

Related U.S. Application Data
(60) Provisional application No. 60/846,979, filed on Sep. 25, 2006.

(51) Int. Cl. G06F 17/50

(52) U.S. Cl. 703/13

(57) ABSTRACT

This application discloses a new, and useful computer implemented method and apparatus that can be used for the determination of SEU and SET disruptions in a cell or circuit, caused by ionizing particle strikes, including those caused by neutrons (cosmic rays), alpha particles or heavy ions. The method of the present invention includes a fast simulation tool (“TFIT”), which calculates the electrical effect of a particle's impact to a cell, or a circuit. The method is used to predict the soft error rate (SER) calculations and the FIT (number of failures-in-time) performance of designated test cell's design, depending on the type of particle environment specified. The method is designed to simulate the response of the cell or circuit to the stimuli caused by a particle strike. These stimuli are modeled as a “current source” placed between the drain and the source of each struck transistor.

### CROSS REFERENCE TO EARLIER APPLICATION

This application claims the priority benefit of U.S. Provisional Application No. 60/846,979 filed Sep. 25, 2006, which is incorporated fully herein by reference.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

1. Field of the Invention

This invention concerns a tool and method for use in the design of circuitry exposed to single event transients (SETs) and single event upsets (SEUs), such as those caused by cosmic rays and ionizing particles impacting the IC device.

2. Description of the Related Art

When an ionizing particle, such as heavy ion, alpha particle, or a secondary ionizing particle created by the nuclear interaction between the neutrons, protons and other particles existing in natural or artificial environments (space, aircraft flight altitudes, ground level, nuclear reactors, etc.) with the atoms of the materials composing an electronic system, strikes an integrated circuit, it creates a track of electron-hole pairs (charge generation process). When the particle track passes through the diffusion area of a transistor or in the proximity of such a diffusion, a transient current pulse is produced on this drain through a charge collection process. If the struck drain belongs to a storage cell (latch, flip-flop, memory cell), the induced transient current pulse may reverse the state of this cell creating a single event upset (SEU). If the struck drain belongs to a combinatorial logic, the induced transient current pulse may be propagated through the subsequent gates of this logic and be captured by a latch or a flip-flop, producing a single event transient (SET). As the size of the transistors of integrated circuits decreases and the amount of devices integrated in such circuits increases, the probability that such an event creates a major problem increases. Numerous experimental data, theoretical analyses, and simulation results have shown the increased sensitivity of latest IC technologies to both SEUs and SETs. A technical problem exists wherein it becomes increasingly important to predict the behavior of integrated circuits under such events as well as their sensitivity to SEUs and SETs in a given environment.

Aggressive technology scaling has led advanced microelectronic technologies to arrive at a turning point as far as these disturbances are concerned: a number of 3D simulations results have already shown the increased sensitivity of IC technologies to both SEUs and SETs. Such results are described in the following articles for example:
[1] P. Roche, J. M. Palau, G. Bruguier, C. Tavernier, R. Ecoffet, and J. Gasiot, “Determination of key parameters for SEU occurrence using 3-D full cell SRAM simulations,” IEEE Trans. Nucl. Sci., vol. 46, no 6, pp. 1354-1362, December 1999.
[2] J. M Palau, G. Hubert, K. Coulie, B. Sagnes, M. C. Calvet, and S. Fourtine, “Device simulation study of the SEU sensitivity of SRAMs to internal ion tracks generated by nuclear reactions,” IEEE Trans. Nucl. Sci., vol. 48, no 2, pp. 225-231, April 2001.
[3] J. M Palau, M. C. Calvet, P. E. Dodd, F. W. Sexton, P. Roche, “Contribution of device simulation to SER Understanding,” IEEE IRPS., no 03CH37400, pp. 71-75, April 2003.
[4] P. E. Dodd, M. R. Shaneyfelt, J. A. Felix, J. R. Schwank, “Production and Propagation of single-Event Transients in High-Speed Digital ICs,” IEEE Trans. Nucl. Sci., vol. 51, no. 6, pp. 3278-3284, December 2004.
[5] V. Ferlet-Cavrois, G. Vizkelethy, P. Paillet, A. Torres, J. R. Schwank, M. R. Shaneyfelt, J. Baggio, J. du Port de Pontcharra, and L. Tosti, “Charge Enhancement Effect in NMOS bulk Transistors Induced by Heavy Ion Irradiation—Comparison with SOI,” IEEE Trans. Nucl. Sci., vol. 51, no. 6, pp. 3255-3262, December 2004.

On the other hand, the various analytical and numeric models available in the literature are not accurate enough to predict the behavior of storage cells and combinational logic irradiated by either heavy ions or neutron fluxes. In addition, although these generic models provide a good qualitative understanding and explanation of the complex mechanisms involved during the charge collection process (drift collection, ambipolar diffusion, charge amplification), they only apply to single MOS devices or SRAMs cells, while they do not take into account the details of the technological process (doping concentrations, device sizes) nor the circuit “environment” associated with the perturbed device or cell (both aspects are known to have a significant influence on the SEE responses). Accordingly a further technical problem exists to improve the accuracy of such analytic models.

Current efforts to address these problems extend to attempts to design specific integrated circuits that are immune to SEUs and SETs, as for example outlined in MAVIS et al, U.S. Pat. No. 6,127,864 dated Oct. 3, 2000. In MAVIS et al an IC device is described, which is immune to SETs and SEUs. The device is a specific sequential circuit having combinatorial logic, including a temporally redundant latch which redundantly samples data from the sequential circuit at multiple time shifted periods, in order to provide multiple, independent data samples from which a correct data sample can be selected. The design of similar as well as other combinatorial logic circuits that are SEU and SET immune requires significant computational simulation and analysis in order to predict the behavior of such circuits. Further technical problems which exist currently include the development of efficient and cost effective simulation tools and methods to simplify the design of such immune circuits.

To predict the behavior of a circuit struck by an ionizing particle, it is important to know the transient current pulse induced on the struck node. This problem was addressed in the paper by G. C. Messenger titled, “Collection of charge on junction nodes from ion tracks,” IEEE Trans. Nucl. Sci., vol. NS-29, no. 6, pp. 2024-2031, December 1982, which is incorporated fully herein by reference. The analytical model proposed by Messenger to determine this current pulse is expressed by a double exponential function as following:

I(t)=IOsec(θ)(e^{(-t/α)}−e^{(-t/β)})
where

### I0 (approximately the maximum current) is only proportional to LET (The particle's Linear Energy Transfer), the remaining factor being constant for a given technology;

β corresponds to the time constant necessary for initially establishing the ion track;
α is the collection time constant of the junction
θ is the angle of incidence of the particle to the surface of the circuit (the total current increases as the angle of incidence varies from grazing to near normal).

This model is simple and requires very low computation time, but there are no proposed approaches for determining the parameters of this model with respect to the particle and circuit characteristics. In addition the accuracy of this model is limited and some extra terms must be added to achieve a good accuracy.

The model proposed by Montpellier and EADS-DASIE [“Contribution of Device Simulation To SER Understanding”, J-M Palau, M-C Calvet, P. E. Dodd, F. W. Sexton, Ph. Roche, IEEE IRPS, 2003, Vol N0 03CH37400, p. 71-75] uses restricted assumptions, namely the preponderance of the ambipolar diffusion mechanism (at the beginning of the process) and the drift collection at a constant velocity close to the struck junction (afterwards).

These assumptions are particularly inaccurate for secondary particles created within the materials of the integrated circuit by interactions of neutrons, protons or other particles. Also, these models only apply to single MOS devices or to SRAMs cells. Furthermore, these models do not take into account the details of the technological process (such as doping concentrations) and they do not consider the device sizes and the circuit surrounding the struck device.

Numerical approaches involving 2D or 3D device simulation are much more accurate. In particular, 3D TCAD device simulation is considered to provide the most accurate results. However, device simulation is very expensive in terms of computation time. This problem is exacerbated because for most environments one has to take into account a large amount of primary or secondary ionizing particles (secondary particles created by the nuclear interaction of neutrons, protons and other primary particles with the atoms composing an integrated circuit), wide ranges of particle energies, and for each particle type and particle energy, large numbers of particle trajectories have also to be considered. Thus, a large number of particle strike configurations have to be simulated to determine the SEU or SET sensitivity of a cell. In most cases, determining the sensitivity of a cell by means of device simulations is computationally intractable. Another limiting factor is the high cost of device simulators, which makes this approach unaffordable for many designers. The latter problem is also exacerbated by the large number of simulations required to characterize SEU or SET sensitivity of a cell under a particle environment, which requires running many simulations in parallel and thus disposing a large number of expensive device simulator licenses.

The technical solutions to these technical problems are addressed by the methods and tools of the present invention, described below.

### SUMMARY OF THE INVENTION

This application discloses a new, and useful computer implemented method and apparatus that can be used for the determination of SEU and SET disruptions in a cell or circuit, caused by ionizing particle strikes, including those caused by neutrons (cosmic rays), alpha particles or heavy ions.

The method of the present invention includes a fast simulation tool (designated herein as “TFIT”), which allows reasonably accurate calculation of the electrical effect of particles impact to a cell, or a circuit early in the design flow. The method is used to predict the soft error rate (SER) calculations and the FIT (number of failures-in-time) performance of designated test cell's design before production, depending on the radiation environment and its characteristics. The TFIT tool of the method can be customized to the users' technology just like internal TCAD effort, thus allowing correlation with silicon test results to be carried out. TFIT interfaces with SPICE simulators so the electrical impact of the particle on a transistor is analyzed on a whole cell or circuit.

The user provides technology data of layout and geometries of NMOS or PMOS transistors to be modeled, including doping profiles, and SPICE model cards. Subsequently, a simplifying equivalent cell is defined and a TCAD model for the cell equivalent is built. The TCAD model comprises parameters for particle LET and LENGTH, coordinates of the particle impact point (X, Y, Z) and trajectory (U), size of the transistor struck by the ionizing particle (either Wn for the strike of an NMOS or Wp for a PMOS), characteristics of the circuit surrounding the struck transistor (either Wp in case of the strike of an NMOS or Wn for a PMOS, and Cload), and Vdd (power supply voltage). Additionally, the characteristics of the particle (or of the set of particles) are defined by the user, by means of the TFIT configuration file, as either light/heavy ions or neutrons. The TFIT tool is designed to simulate the response of the cell or circuit (also defined by the user) to the stimuli caused by a particle strike. These stimuli are modeled as a “current source” placed between the drain and the source of each struck transistor. The TFIT tool places a current source element between the source and the bulk node of each of the transistors struck by the ionizing particles, modifying the related SPICE netlist accordingly. The TFIT interface tool then uses the TCAD model data, the particular particle environment and the struck transistor “neighborhood” to compute values for the current source caused by simulated particle strikes, and places these values in the respective current source elements. A second SPICE simulation is run to compute either the FIT (in a neutron environment) or the SET characteristics or SER for one or a set of ionizing particles (in a light or heavy ion environment). These simulations provide data to predict the behavior of complex MOS gates to SET, as well as the response of SRAM cells to SEU aggressions (the threshold LET as well as the cross-sections can be predicted with reasonable accuracy). If desired, this TCAD model can be used to simulate the electrical behavior of entire circuits where one or several MOS transistors are irradiated by either heavy ions or neutron fluxes. Output reports are generated from these simulations to quickly and efficiently provide circuit designers with adequate data which should help to perform the design modifications necessary to offset the results of SEU and SET disruptions.

### BRIEF DESCRIPTION OF THE SEVERAL VIEWS OF THE DRAWINGS

FIG. 1 shows a modified Messenger current, including an additional linear contribution.

FIG. 2 indicates the conventions of notation of the X-Y coordinate system for a particle striking the silicon surface as used in the invention description.

FIG. 3 shows a pictorial description of an Ionizing particle track located in the sensitive drain volume, and its equivalent Xright value (that is, the position of the impact point at the silicon surface).

FIG. 4 depicts an Ionizing particle track starting in the sensitive drain volume characterized by an angle of incidence Q for computation of the value of the equivalent Zion parameter (Zeq).

FIG. 5 depicts an inverter gate having an n transistor and a p transistor.

FIG. 6 depicts an exemplary NOR gate used to depict a transient current pulse created by a particle strike, which will be injected on the output line Out.

FIG. 7 depicts an inverter that will collect a similar transient current pulse to that described with respect to FIG. 6.

FIG. 8 depicts an equivalent circuit for use to show the case where the particle strikes a p-type transistor.

FIG. 9 depicts an equivalent circuit to determine the current pulse for particles striking the n-type transistors of complex gates.

FIG. 10 depicts a simplified flow chart of the method of the current invention.

FIG. 11 depicts the data structure in general of the Response Model File.

FIG. 12 depicts a simplified flowchart of the iterative process used in building the TCAD model.

FIG. 13 depicts a data structure for an exemplary TFIT configuration file.

FIG. 14 depicts an exemplary output report showing a set of TCAD current sources corresponding to a struck transistor and particle impacts.

FIG. 15 depicts an exemplary TFIT output report showing the steps of the first SPICE run and exemplary outputs for Ceff and Ieff.

FIG. 16 depicts an exemplary TFIT output report showing the computed effects of centered impacts of particles, and various other final output values such as DX, which allows the computation of SRAM cross-sections.

FIG. 17 depicts the basic functionality of TFIT.

### DETAILED DESCRIPTION OF THE INVENTION

Glossary and Definitions:

3D TCAD suite: set of numerical tools designed to simulate the process and device behavior of integrated circuits components, using a three dimension finite-element method.
Ambipolar diffusion mechanism: diffusion mechanism due to dense free carrier concentration plasma.

### CLOAD: output capacitance located at the inverter output and/or output capacitance seen by the drain of the hit MOS transistor for a more complex gate and/or circuit.

### DESSIS™: Device simulator from SYNOPSYS TCAD suite

LET: Linear Energy Transfer of an ionizing particle striking a transistor. It represents the charge deposited by unit length into the device, in pC/mm

### FIT: Failure In Time, or number of errors per 10e9 device hours.

### GENESISe™: Graphical user interface and design of experiment tool from SYNOPSYS TCAD suite.

### SEE: Single Event Effect.

SER: Soft error rate. Soft error rate (SER) is the rate at which a device or system encounters or is predicted to encounter soft errors. It is typically expressed as either number of failures-in-time (FIT), or mean-time-between-failures (MTBF). The unit adopted for quantifying failures in time is called FIT, equivalent to 1 error per billion hours of device operation. MTBF is usually given in years of device operation. To put it in perspective, 1 year MTBF is equal to approximately 114, 155 FIT.
SPICE: is a general-purpose circuit simulation program for nonlinear dc, nonlinear transient, and linear ac analyses. Circuits may contain resistors, capacitors, inductors, mutual inductors, independent voltage and current sources, four types of dependent sources, lossless and lossy transmission lines (two separate implementations), switches, uniform distributed RC lines, and the five most common semiconductor devices: diodes, BJTs, JFETs, MESFETs, and MOSFETs. A component described at the SPICE level means that it is described within DESSIS mixed-mode engine as a SPICE element.
Technological process refers to doping concentrations and other characteristics of the manufacturing process. Process parameters: for a typical technological process, doping concentrations and geometry of the 3D simulated device or cell (this includes the layout description in 3D as well as the SPICE models in the case of mixed-mode).

### VDD: Device Power Supply voltage.

### Weff: the equivalent width of the NMOS (or PMOS) transistor in series with the struck PMOS (or NMOS) device, when the inverter representation is used as the cell model equivalent definition.

### DRAIN: the diffusion area struck by a ionizing particle, it could be either a DRAIN or a SOURCE depending on the studied cell configuration.

First reduction model: model based only on the polarization conditions of a single struck transistor (drain-source voltage) as circuit parameter.
Second reduction model: model based on the parameters of circuit surrounding the struck transistor (width of the non-struck transistor, output capacitance, Vdd level.

### DETAILED DESCRIPTION

In nanometer designs, soft errors have become an issue that must be considered during the design phase. An accurate and fast simulation method is needed for users who have the ability to modify the cell design (IDMs, libraries developers). The method of the present invention is controlled by a fast simulation tool (designated herein as “TFIT”), which is used to predict the soft error rate (SER) calculations and the FIT performance of their design before production.

TFIT allows reasonably accurate calculation of the electrical effect of particles impact to a cell, or a circuit early in the design flow, at much faster speeds that traditional 3D TCAD simulations (whereas the 3D TCAD approach does not apply in the case of neutrons impact and circuits analysis). Furthermore, TFIT can be customized to the users' technology just like internal TCAD effort, thus allowing correlation with silicon test results to be performed. TFIT interfaces with Spice simulators so the electrical impact of the particle on a transistor is analyzed on a whole cell or circuit. Particles can be either neutrons (cosmic rays), alpha particles or heavy ions.

In the method of the present invention, TFIT is an engine that uses different pieces of information as input, such as for example:
Two current pulse models (NMOS, PMOS) of the foundry's technology (to be developed on a case by case basis);
The spice model cards corresponding to the studied technology;
A database of nuclear reactions between Si, O and neutrons (for the neutron case);
The spice netlist of the cell or circuit; and
A description of the radioactive environment to be considered.

As an output, TFIT provides the user with for example:
the Soft Error FIT rate of the studied cell for the described environment; and
the SPICE output files describing the electrical behavior of the struck cell or circuit.

The following describes a computer implemented method and apparatus that can be used to solve the technical problems including the inaccuracies and/or the computational problems related with the preexisting methods as described above. The apparatus and method described herein, are used for the determination of SEU and SET disruptions in a circuit, caused by ionizing particle strikes, including those caused by neutron or heavy ion particles.

The characteristics of the particle (or of the set of particles) are defined by the user himself by means of the TFIT configuration file. The TFIT tool is thus designed to simulate the response of the cell or circuit (also defined by the user) to the stimuli caused by a particle strike. These stimuli are modeled as a “current source” placed between the drain and the source of each struck transistor. This current source could be either a “modified Messenger current” or a current computed by a “neural network software”, or a current calculated by means of a “first or second reduction model,” as described in more detail below.

The method can use a special mode (“XY”) within TFIT, which allows the computation of heavy ion cross-sections for SRAMs. In the case of neutrons, a special database of nuclear reactions between SI, O and neutron particles is used to determine the set of secondary ions generated by the neutron. These particles are characterized in the same way as they are in the heavy (or light) ions case, namely by their LET, RANGE, coordinates of the impact point, trajectory. Thus the neutron case is treated (more or less) in the same manner as the heavy ion case, except that the response in which we are interested is the FIT of the cell or circuit. In the heavy ion case, it is usually a cross-section (whose value is derived from the computed “DX” or sensitive area, that is, the distance from the drain DX above which the SRAM does not switch anymore) that is of interest.

Generally, in an exemplary embodiment, the method comprises the acts of:
providing technology data of layout and geometries of NMOS or PMOS transistors to be modeled, including doping profiles and SPICE model cards;
defining a cell equivalent (usually an inverter) that will become the cornerstone of the TCAD model that is explained in more detail below;
building a TCAD model for this specific cell equivalent, the TCAD model comprising parameters for particle LET and LENGTH, coordinates of the particle impact point (X, Y, Z) and trajectory (U), size of the transistor struck by the ionizing particle (either Wn for the strike of an NMOS or Wp for a PMOS), characteristics of the circuit surrounding the struck transistor (either Wp in case of the strike of an NMOS or Wn for a PMOS, and Cout), and Vdd (power supply voltage), the TCAD model being designed to compute a current source to be placed between the source and drain of each of the transistors struck by the ionizing particles;
Using the TCAD model and a TFIT interface program tool, to apply the TCAD model to the target test circuit (by means of a current source applied at each struck node), and executing SPICE simulations to predict the behavior of complex MOS gates to SET, as well as the response of SRAM cells to SEU aggressions (the threshold LET as well as the cross-sections can be predicted with reasonable accuracy); and if desired, using this TCAD model to simulate the electrical behavior of entire circuits where one of several MOS transistors are irradiated by either heavy ions or neutron fluxes.

Output reports are generated from these simulations to quickly and efficiently provide circuit designers with adequate data which should help to perform the design modifications necessary to offset the results of SEU and SET disruptions.

This method and its elements will now be described in more detail in terms of an exemplary description and the currently used best mode.

The method uses the results of a set of mixed-mode simulations (that is simulations where only the hit device is modeled at the physical level, the surrounding circuit being simulated at the SPICE level), in order to create empirical models describing the transient current pulse induced by the impact of an ionizing particle on an element of a circuit cell. These simulations are performed once producing a set of current responses for the various input parameters. Afterwards, the created current response model (TCAD model), and the TFIT interface program tool, allows any user to determine the transient current pulses created by ionizing particles striking the sensitive nodes of a cell, such as a storage cell, an inverter, or a complex gate such as NOR, NAND, TRISTATE, . . . . These determinations are therefore made at low computational cost and without employing any device simulator. The created empirical models either produce the transient current pulse itself, or produce the parameters of an analytical model of the transient current pulse.

Extensive silicon testing and simulations have been done, which allowed the inventors to demonstrate the feasibility of this method and the advantages of the derived empirical models with respect to preexisting models and in particular:
a high accuracy (close to the results of 3D mixed-mode device simulation),
the ability to take into account the parameters of the technological process, and,
the ability to take into account the characteristics of the circuit surrounding the struck transistor.

The inventors have demonstrated that a few hundred 3D device-mixed-mode simulations are sufficient for creating a highly accurate transient current pulse model, which can be used afterwards by designers to determine the transient current pulses for various cells (storage cells, logic gates, etc.) and for various particle environments. In particular, due to the large number of particle types, particle energies and particle trajectories that should be considered in most environments to characterize the sensitivity of a cell, such as a memory cell or a logic gate, the number of particle strikes that should be simulated for performing such a characterization can be very high. This number will often exceed the number of simulations required for creating our model. Thus, with a number of simulations that in most cases will be lower than the number required for characterizing the sensitivity of a single cell, we obtain a model (also called TCAD model) that can be used to characterize a plurality of cell types, employing a wide range of transistor sizes, and used in a wide range of circuit environments.

Two schemes are developed for creating such a TCAD model.

The first scheme starts from an analytical model of the transient current pulse and uses device-mixed-mode simulations to create empirical models for each one of the parameters involved in the analytical model.

The analytical model proposed by Messenger has been used in this manner, but it was found that this model could not give results of high accuracy. Thus we have expanded this model, in the CMOS inverter case, by adding a piece-wise linear current. This contribution is designed to account for the saturation current flowing through the initially ON-PMOS (or ON-NMOS) component described in the SPICE domain. This additional current source introduces 3 more parameters:

_t0: delay associated to this constant current source

_ta, tb: the two related cut-off times.

The current source formula proposed for use with this invention is then expressed as follows:

$$l ( t ) = I 0 sec ( θ ) ( {e}^{( \frac{- t}{α} )} - {e}^{( \frac{- t}{β} )} ) + lcst$$

$$\text{Where} \text{:}$$

$$\begin{matrix}lcst = 0 & for t < t 0 \\ lcst = lsat ( Spice ) [ NMOS or PMOS ] & for t 0 < t < ta \\ lcst = lsat \cdot exp ( - ( t - ta ) / tb ) & for t > ta\end{matrix}$$

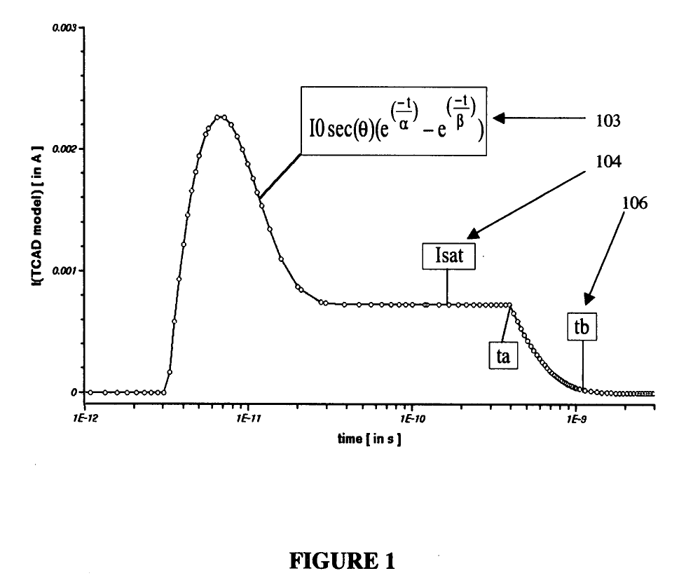

FIG. 1 depicts a graph of this modified Messenger current in Amps over time in seconds.

The second scheme does not employ preliminary analytical expression of the transient current pulse but uses simulation results to create a completely empirical model of the transient current pulse.

The generation of the empirical models of the parameters involved in the analytical model of the current pulse for the first scheme can be done manually or automatically, the creation of the empirical model of the current pulse for the second scheme being performed automatically.

The manual approach is not recommended as it is a complex and fastidious task. However, Applicants have demonstrated that the manual approach is feasible in particular for the first scheme where the use of a pre-established analytical model simplifies this task. In this case Applicants manually obtained transient current pulse models of high accuracy.

The automatic approach is performed by using computers and employing algorithms, which allow building complete response models. Furthermore, these response models will enable one to extrapolate the solution to other points than the reduced set of input/output responses used for the model creation. Various algorithms can be used for this task, such as for instance, algorithms generating a polynomial form of the transient current pulse I, or adaptive algorithms such as neural networks. After a preliminary phase where the results of the simulation are used to establish the model, the neural system model can be used to provide the response for non-simulated points of the model space. With this approach it is possible to obtain totally empirical models of reasonably high accuracy.

An issue for creating an accurate model is the selection of the input parameters of the model. One of the reasons for the insufficient accuracy of previous models is the use of an insufficient set of input parameters. Thus, the model proposed in the paper referenced in the introduction [J. M Palau, M. C. Calvet, P. E. Dodd, F. W. Sexton, P. Roche, “Contribution of device simulation to SER Understanding,” IEEE IRPS., no 03CH37400, pp. 71-75, April 2003] uses as input parameters: the particle LET (linear energy transfer) which represents the amount of energy that the particle looses per unit length of its trajectory, the particle range (referred hereafter as LENGTH), the particle trajectory characteristics and the size of the transistor struck by the ionizing particle (basically the size of its drain).

Applicants' simulation experiments showed that the shape and intensity of the transient current pulse are also sensitive to circuit characteristics other than the size of the struck transistors, and in particular to the characteristics of the circuit surrounding the struck transistor (referred hereafter as the surrounding circuit) which are not considered in the above model. Also, the other known model, (Messenger's model) is an abstract model, which does not use any circuit related parameters, whereas in our case, the circuit effects are explicitly taken into account (Messenger's parameters are directly extracted from 3D simulation current curves). To achieve a high accuracy, the models described herein will have the general form f(LET, LENGTH, particle trajectory, size-of-drain-of-struck-transistor, characteristics-of-the-surrounding-circuit). Where LET is the particle LET. The trajectory of the particle can be determined by three parameters: d (distance from the struck transistor), q and f (angles determining the direction of the particle trajectory). Because the length of transistors is fixed in a given process, it may be convenient to create a model where the only variable that characterizes the size of the struck transistor is its width, referred hereafter as W[struck transistor]. In this case the model will have the form f (LET, LENGTH, particle trajectory, W[struck transistor], characteristics-of-the-surrounding-circuit).

The struck transistor usually belongs to a cell such as a storage cell (memory cell, latch, flip-flop, etc.), a logic gate, a TRISTATE gate, . . . . For convenience, the cell which includes the transistor struck by the ionizing particle will be referred to as the “struck cell”. The characteristics of the surrounding circuit are the size and configuration (connectivity) of the other transistors of the cell, their electrical state (ON or OFF), as well as the characteristics of the other cells connected with the struck cell. The cells that drive the transistors of the struck cell will determine the electrical state (ON or OFF) of these transistors. The cells that are driven by an output of the struck cell will determine the load “Cout” of this output. Thus, Applicants can take into account the impact of the cells connected to the struck cell by considering the electrical state of the transistors of this cell and the loads of its outputs. Further, in most digital designs these loads are capacitive. The models used herein will take the form f(LET, LENGTH, d, q, f, W[struck transistor], size-configuration-and-electrical state of the non struck transistors of the cell, Cout), where for simplicity we have considered a cell with a single output. In the case of an inverter the model will have the form f(LET, LENGTH, d, q, f, W[struck transistor], W[non-struck transistor], Cout). By introducing Cout as an input variable in our model we take into account all possible configurations of the cells driven by the struck cell.

As a particular example, the model generated for an inverter can be used to determine the transient current pulse induced when a particle strikes a transistor of an inverter belonging to a memory cell. In this case, the influence of the cells driven by the inverter is taken into account by allocating to the variable Cout of the model, the value that takes the output capacitance of the inverter within this memory cell. Also, the model can be used for cells in which the capacitance Cout is variable. In fact, the value of Cout may depend on the electrical state of the struck cell and of the cells it drives. In this case, the model can be used to determine the current pulse for a given electrical state of the circuit. This is done by allocating to the variable Cout of the model, the value of Cout corresponding to this electrical state

In modern technologies, various Vdd levels can be used to trade circuit performances such as speed, power dissipation and reliability. Hence, to provide a flexible transient pulse model that covers all possible circuit cases, Vdd has also to be added to the model parameters, Hence our models will have the form f(LET, LENGTH, d, q, f, W[struck transistor], size-configuration-and-electrical state of the non struck transistors of the cell, Cout, Vdd), where for simplicity we have considered a cell with a single output. In the case of an inverter the model will have the form f(LET, LENGTH, d, q, f, W[struck transistor], W[non-struck transistor], Cout, Vdd).

### Best Mode

In this Best Mode section we describe the computers, and programs presently used as well as the theoretical basis and methods developed to reduce the number of model parameters required for efficient simulations, which nevertheless produce the required accuracy in the evaluation of the various target ICs. Those skilled in these arts will recognize that equivalent computer hardware and software systems can be used, as well as compatible models of the simulation packages employed without deviating from the essence of the current invention. Similarly, additional theoretical mathematical analysis and equivalency reduction techniques may be used to further simplify the essential parameter selection and model constructions, without deviating from the essence of the invented method and tool described herein.

At the present time the computers and program editions used are as follows:

1) SPICE:
SPECTRE: 5.0.33 up to 6.1.1
HSPICE: 2005.03 up to 2005.09

2) TCAD tools: ISE 9.5.3 up to tcad_sentaurus_vY-2006.06

3) Spice Model card for MOS devices:
BSIM3
BSIM4

4) TFIT: Version 1.0 up to 2.0

5) platforms:
IBM server: 8 processors, each of them being an Intel XEON 32 bits, Linux OS Readhat AS3
Sun: sun4u, sparc SUNW, Ultra-80, Solaris 9 (5.9)

At the present time, the following theoretical analysis has been used to construct the models used in the present invention.

Methods for Reducing the Number of Modeling Parameters

Using a large number of parameters in the model requires a large number of device simulations or experiments to obtain sufficient data to create an accurate model and then it makes it more difficult to create the model from these data. Reducing the number of parameters will therefore simplify significantly the model generation effort.

Method for Reducing the Number of Parameters Describing the Particle Trajectory

The parameters determining the particle trajectory are the distance from the struck drain and the angles q and f of the trajectory which are, for the time being, treated in the same manner (it means we do not yet distinguish the separate effects of these two angles since we have been considering, up to now, that the influence of f is strictly similar to that of θ). The invention uses several formula to reduce these parameters.

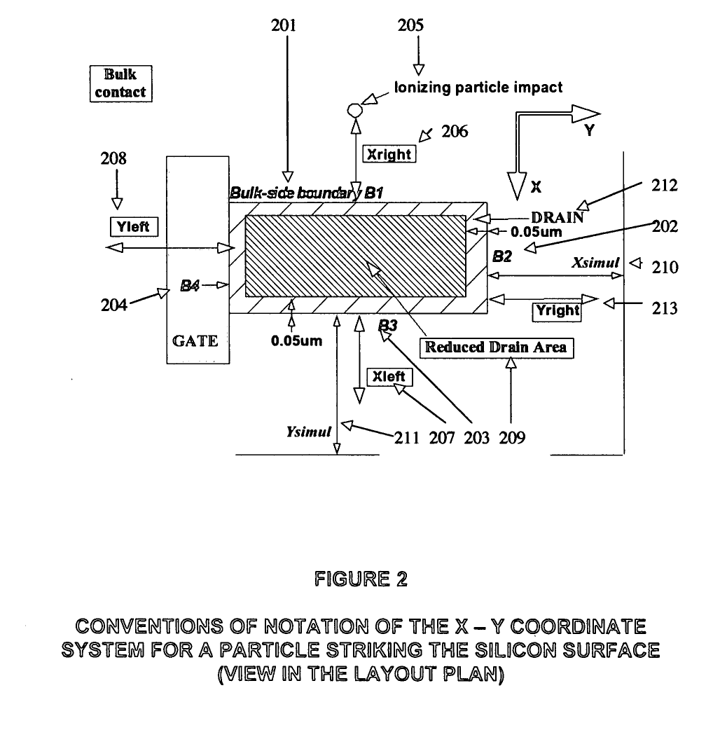

Referring now to FIG. 2, an ionizing particle can strike the top surface of a silicon device at any point of the simulated domain. The X-Y references of the domain are defined thanks to the four external boundaries of the physical drain area: B1 (also called Bulk-side boundary) (201), B2 (202), B3 (203) and B4 (204). For instance, Xright (206) is the distance between the boundary B1 (201) and the impact point of a ionizing particle (205) striking the silicon surface along a vertical line located at the middle of the drain (Y=Y0=middle of the drain (212)). We define a reduced drain area (209), as a subset of the physical drain area, determined by four new boundaries located inside the drain area, at a distance of 0.05 um from B1 (201), B2 (202), B3 (203), and B4 (204), as shown in FIG. 2.

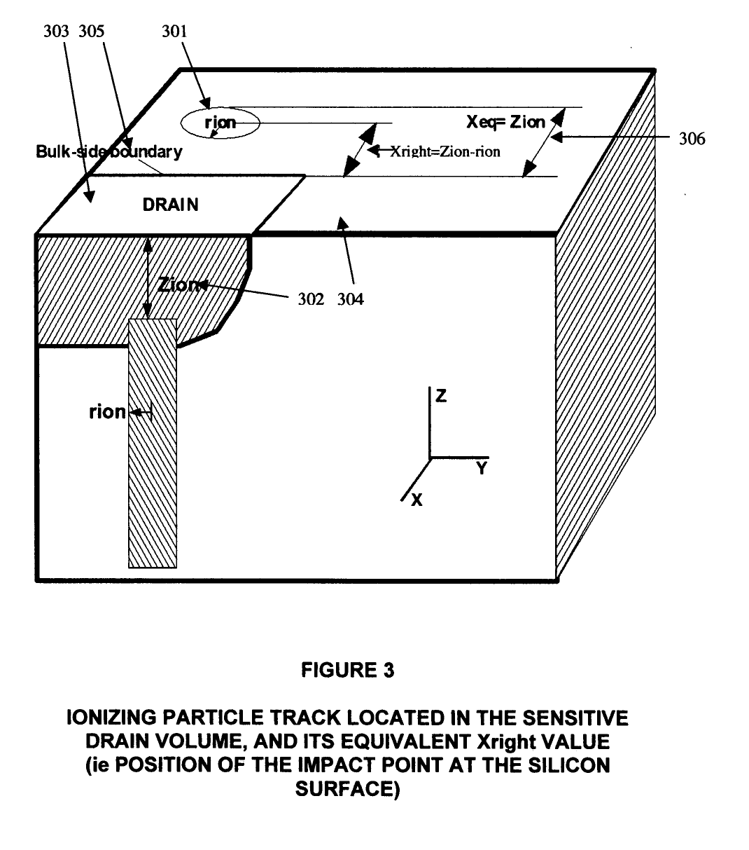

Referring now to FIG. 3, the impact point is defined as the center of the ionizing particle track. This track is considered as a cylindrical column of electron-hole pairs of radius rion (301). The value we usually retain in the simulations for rion is 0.07 um (a value commonly used in the literature).

When the impact point of the ionizing particle is located inside the reduced drain area, our experience shows that the response of the 3D mixed-mode cell does not vary significantly. Moreover, an impact within this region corresponds to a maximum current pulse, and thus to a maximum perturbation of the 3D mixed-mode cell. When the impact point is located outside the reduced drain area, and is moving away from one of its four boundaries, the current pulse becomes weaker, this observation being well known from the literature.

1-Influence of Xright, Xleft, Yright, Yleft: Reduction of these 4 Variables to a Single One (Xright)

Referring again to FIG. 2, the inventors have established that:

a—The attenuation of the cell response (with respect to a strike located in the reduced drain area (209)) is nearly exactly the same, along Yright (213) and Xleft (207), when the simulation volume surrounding the initial ion track is about 14 times the track radius. This simulation volume, defined by the two distances Xsimul (210) and Ysimul (211), is chosen such as Xsimul=Ysimul=Dsimul=14 rion, to meet this requirement. This approximation can be used, still representing accurately enough the reality, in order to remove one of these two space variables, namely Yright (213), from the set of 3D simulations. This allows reducing the number of 3D device simulations required to build our model, as well as it enables reducing the complexity of the model itself.

b—The cell response attenuation associated to a Yleft (208) variation is also found to be approximately the same as the attenuation along Yright (213), although the proximity effects of the source contact make this rule less accurate than in the previous case. Indeed, the cell response attenuation along Yleft (208) is more pronounced than along Yright (213), because part of the initial deposited charge is collected by the source, rather than by the drain, when the impact point moves towards the source. Nevertheless, the error stays reasonable, and we can use this approximation to assimilate the effects of Yleft (208) to those of Yright (213), which will contribute to reduce the number of 3D simulations points as well as the complexity of our model. When this assumption is made, this leads to the fact that only 2 space variables have to be modeled: Xleft (207) (from which the Yleft (208) behavior, as well as the Yright (213) reply, can be inferred) and Xright (206).

c—Knowing that the simulation domain along Xright (206) is greater than 14 rion, we found out that the cell response along Xright (206) is fairly close to the reply along Xleft (208), although the bulk proximity, in the case of Xright (206), implies a slight discrepancy due to the bulk collection more or less significant according to the considered case. We can thus use this approximation, which neglects this slight disagreement, in order to narrow the number of 3D simulations as well as the model complexity.

Therefore, by doing the above three assumptions, the analysis of the cell response, for an impact point located at the silicon surface, can be reduced to the analysis of one single space variable: Xright (206).

2-Influence of Zion: Reduction of this Variable to its Xright Equivalent

Referring again to FIG. 3, Ionizing particle tracks may also be initiated inside silicon: for instance, a neutron-silicon nuclear reaction can create a secondary ionizing particle inside or below the drain volume. This case introduces an additional parameter to our model, namely the vertical distance from the silicon surface at which the particle track starts. This is shown in FIG. 3 where a particle track starts within the drain volume at a distance Zion (302) from the drain surface. Adding this extra parameter, Zion, makes the model more complex and requires a higher number of 3D device simulations to be performed. Furthermore, it makes the model creation task more complex.

In order to simplify this model, our experience showed than we can replace the Zion (302) parameter by using an Xright equivalent value. Indeed, we found that a particle impact located in the drain sensitive area (303), at a vertical coordinate Zion (302) from the silicon surface (304), has the same effects on the cell response as a strike at the silicon surface, located at an equivalent Xright coordinate measured from the bulk-side boundary (305), as shown in FIG. 3. An analytical formula has been built to compute, for every Zion value, the equivalent Xright coordinate, which would provide the same response as the Zion impact:

Xright(equivalent)=Zion−rion=Zion−0.07 um (where rion=0.07 um).

This rule means that an ionizing particle, whose initial electron-hole plasma has a radius of rion (301), and whose impact point is located within the silicon substrate, just underneath the drain region, has nearly the same perturbation effects as a particle striking the silicon surface at a position such that the external envelope of the free carriers plasma is situated at a distance Xeq=Zion (306) from the bulk-side boundary (305).

This law, together with those previously described, allows reducing the number of spatial variables (Xright, Xleft, Yright, Yleft, Zion) to a single one, namely: Xright. The model linking the variation of the cell response to Xright enables the computation of all remaining necessary surface responses.

3-Influence of θ: Reduction of this Variable to its Zion Equivalent

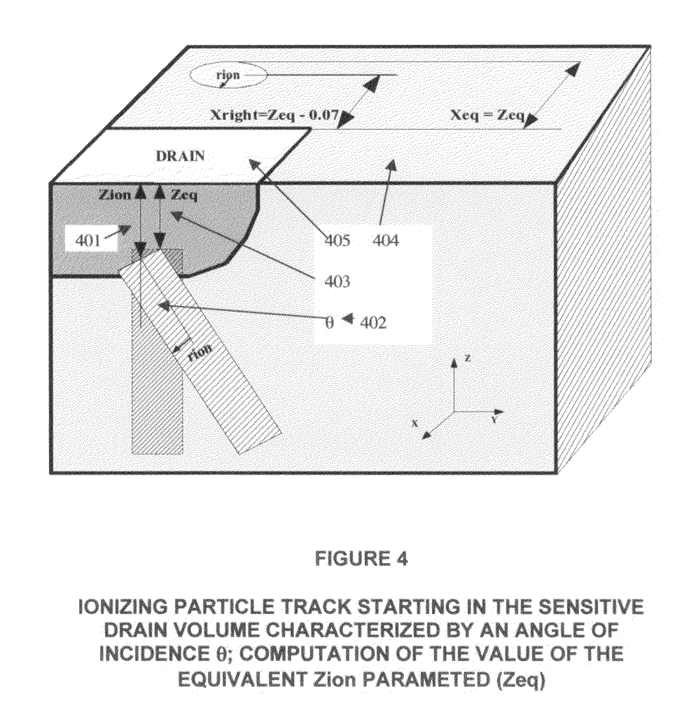

Referring now to FIG. 4, Ionizing particle tracks initiated inside silicon, for instance a secondary ionizing particle due to a neutron-silicon nuclear reaction, have in most cases an oblique incidence. This case also introduces an additional parameter to our model, namely the angle formed between the particle trajectory and the vertical axis Z. This is shown in FIG. 4 where the particle track, starting within the drain volume at a distance Zion (401) from the surface (404), forms an angle θ (402) with the vertical axis. Adding this extra parameter makes the model more complex to create and requires a greater number of 3D device simulations to be carried out.

In order to simplify the model, our investigations showed than we can replace the Zion (401) parameter by an equivalent Zion value (Zeq) (403), which will take the influence of θ into account. Indeed, a particle track with an angle of incidence θ, located in the drain sensitive area (405), at a vertical coordinate Zion (401) from the silicon surface (404), induces the same perturbation as a vertical strike (angle of incidence θ=0) located at a coordinate Zeq (403), as shown in FIG. 4. An analytical formula is used to compute, for every θ value, the equivalent Zeq coordinate, which would provide the same cell response:

$$\begin{matrix}Zeq = Zion - rion * cos ( ( 90 - abs ( θ ) ) \\ Zion - 0.07 \text{um} * cos ( ( 90 - abs ( θ ) ) \\ ( \text{where} rion = 0.07 \text{um} )\end{matrix}$$

Additionally, the effects of Zeq are computed after applying the Xright conversion rule:

Xright(equivalent)=Zeq−rion

The θ rule means that any ionizing particle, whose initial electron-hole plasma has a radius of rion, whose impact point is located within the silicon substrate, just underneath the drain region, and whose track forms an angle of θ with the vertical axis, has nearly the same effects as a particle with a vertical track, whose location inside the silicon corresponds to the closest distance between the initial particle track and the silicon surface.

This last law allows reducing the number of spatial variables (Xright, Xleft, Yright, Yleft, Zion, θ) to a single one, namely: Xright. The model linking the variation of the cell response to Xright enables the calculation of all remaining necessary surface responses.

Method for Reducing the Number of Circuit Parameters

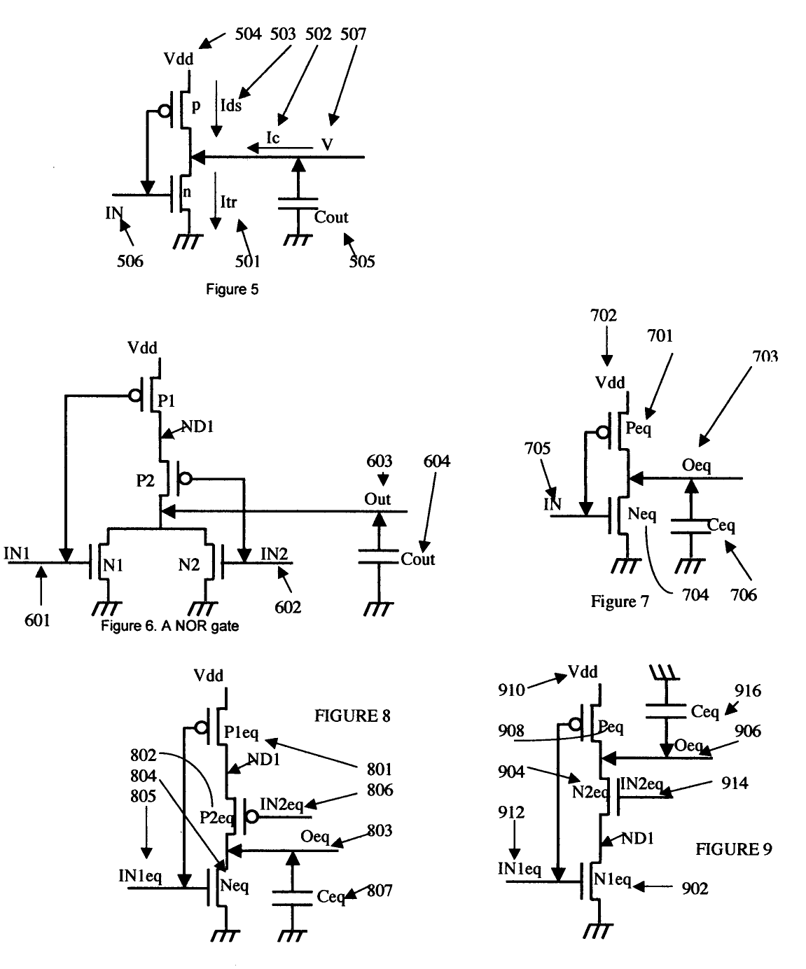

FIG. 5 shows an inverter gate composed of an n and a p transistor. The input line (IN) (506) drives the gates of the n and p transistors. The output capacitance (load) is Cout (505) and the output voltage is V (507). We consider as example the case where IN=0 (ground level). In this case, the transistor n is off, the transistor p is on and the output voltage V is equal to the Vdd (504) level. The node sensitive to ionizing particle strikes is the drain of the off transistor. Hence, we consider an ionizing particle striking the drain of the n transistor. The particle strike creates a transient current Itr (501), flowing through the n transistor as shown in the figure. In the figure we also see the current Ids (503) flowing through the p-MOS, and the current Ic (502) discharging the capacitance Cout (505). Let Ids(t), and Ic(t) be the values of these currents at time t and V(t) be the output voltage at time t. For a given particle LET and particle trajectory, the transient current Itr(t) is determined by the circuit parameters (W[struck transistor], W[non-struck transistor], Cout, Vdd).

A way to reduce the number of parameters is found by considering the polarization of the struck transistor, which is determined by its drain source voltage. In our example the struck transistor is the n transistor, and its drain source voltage is equal to the output voltage V(t) of the inverter. Using device simulations or experimental measurements we can determine the function Itr=fₙₜ(t, V (t)=Vi), which gives the transient current pulse Itr for a constant value Vi of its drain-source voltage. By repeating device simulation/or experimental measurements for several values (V₀, V₁, . . . , Vₙ) of the output voltage V, we obtain the function Itr=fₙₜ(t, V) which gives the current flowing through the struck n-MOS as a function of time and of its drain-source voltage V, where V is a discrete variable taking the values (V₀, V₁, . . . , Vₙ).

For the p transistor (the non struck one), the drain source voltage at time t is Vds=V(t)−Vdd. The function Ids=fₚ(V−Vdd) which gives the current flowing through the p transistor as a function of its drain-source voltage Vds (Ids/Vds transfer characteristic of the p transistor), can be obtained by using a SPICE simulator.

At any time t we have Itr(t)=Ids(t)+Ic(t). We have also Ic(t)=−Cout(dV/dt)=−Cout(V(tᵢ₊₁)−V(tᵢ))/(tᵢ₊₁−tᵢ). Then we have Itr(tᵢ₊₁)=Ids(tᵢ₊₁)−Cout(V(tᵢ₊₁)−V(tᵢ))/(tᵢ₊₁−tᵢ). Replacing Itr(tᵢ₊₁) and Ids(t₊₁) gives fₙₜ(tᵢ₊₁, V(tᵢ₊₁))=fₚ(V(tᵢ₊₁)−Vdd)−Cout(V(tᵢ₊₁)−V(tᵢ))/(tᵢ₊₁−tᵢ). If we know V(tᵢ) at time tᵢ, then the only unknown in this equation is V(tᵢ₊₁). By resolving it numerically we obtain the value V(tᵢ₊₁) at time tᵢ₊₁. We can start from the instant t₀ where we have V(t₀)=Vdd (value of V before it is affected by the particle strike). From this value we determine V(t₁) at instant t₁. Then, from this value we determine V(t₂) at instant t₂, and son on. Alternatively we can use the equation fₙₜ(tᵢ, V(tᵢ))=fₚ(V(tᵢ)−Vdd)−Cout(V(tᵢ)−V(tᵢ₊₁))/(tᵢ−tᵢ₊₁), which allows a faster resolution as the unknown V(tᵢ₊₁) does not appear within the functions fₙₜ(t, V(t)) and fₚ(V(t)−Vdd), then, the current Itr at time tᵢ₊₁ being extracted from V(tᵢ₊₁) using: Itr(tᵢ₊₁)=fₙₜ(tᵢ₊₁, V(tᵢ₊₁)).

This way, we obtain the discrete function V(tᵢ)=fᵥₜᵣ(tᵢ) at instants t₀, t₁, . . . , tᵢ, . . . , and by interpolation we obtain the function of the transient current pulse Vtr=V(t)=fᵥₜᵣ(t) for other values of t. This function gives the output response of the inverter to the particle strike (voltage transient pulse). From Itr=fₙₜ(t, V), we obtain Itr=fₙₜ(t, fᵥₜᵣ(t)=fᵢₜᵣ(t), which gives Itr as a function of time only (current transient pulse).

For a particle striking the p transistor of the inverter a similar method leads to the equation

fₚₜ(tᵢ,V(tᵢ)−Vdd)=fₙ(V(tᵢ))−Cout(V(tᵢ)−V(tᵢ₊₁))/(tᵢ₋tᵢ₊₁).

It is clear that the accuracy of this computation depends on the resolution used to make the computations. First, the temporal step (tᵢ₊₁−tᵢ) has to be short to reduce the error introduced when replacing dV/dt by (V(tᵢ₊₁)−V(tᵢ))/(tᵢ₊₁−tᵢ). Second, the functions Ids=fₚ(V−Vdd) and Itr=fₙₜ(t, V) must have a good resolution on variable V and t. SPICE simulators provide a template for function Ids=fₚ(V−Vdd) with a high resolution for V. Also, for a given value Vi of V as well as given particle LET and given particle trajectory, device simulation provides a template for function Itr=fₙₜ(t, V=Vi) with a high resolution for the time variable t. However, for creating the function Itr=fₙₜ(t, V) with a high resolution for variable V, we must perform device simulations for a large number of values Vi.

This method was proposed in the paper “Estimation of Single Event Transient Voltage Pulses in VLSI Circuits from Heavy-Ion-Induced Transient Currents Measured in a Single MOSFET”, Kobayachi et al, Radecs 2006 Workshop, Greece, to determine the output voltage response of an inverter of given size (width of n transistor and width of p transistor) and for given particle LET and trajectory. The applicants used a graphical method to implement the relationships we represented above by means of functions. They also use a graphical method to determine the output voltage of the inverter at different instants of time. Because their goal was limited to given transistor width, particle LET and particle trajectory, it is feasible in these conditions to perform a significant number of simulations to obtain the transient current Itr for a significant number of values Vi for parameter V. On the other hand, the aim of this invention is to develop a generic transient current model where the size of struck transistor, particle LET and particle trajectory are variables of the model. Because we have to perform device simulations by varying all these parameters, using a large number of values for parameter V will increase significantly the number of simulations and require very large computation time.

To cope with this problem, Applicants select a reduced number of values Vi for parameter V and use an interpolation technique to determine the function Itr=fₙₜ(t, V) for other values of V. For instance, if we know fₙₜ(t, Vi) and fₙₜ(t, Vk) we can determine fₙₜ(t, Vj), with Vi<Vj<Vk, by interpolating it from fₙₜ(tᵣ, Vi) and fₙₜ(tᵣ, Vk) at any time tᵣ. We can use an interpolation law which is linear around each value Vj: fₙₜ(tᵣ, Vj)=fₙₜ(tᵣ, Vi)+(fₙₜ(tᵣ, Vk)−fₙₜ(tᵣ, Vi))(Vj−Vi)/(Vk−Vi), or more complex interpolation laws.

Two kind of models for the transient pulse can therefore be elaborated:

A first transient pulse model (also referred to as a “first reduction model”) based on the polarization conditions of the struck transistor (drain-source voltage) as circuit parameter; and

A second model (also referred to as a “second reduction model”) based on the parameters of circuit surrounding the struck transistor (width of the non-struck transistor, output capacitance, Vdd level).

The first transient pulse model uses two parameters less than the second. Thus it requires less simulation or experimental data and is easier to establish. This model of the transient current pulse will have the following parameters [struck transistor width, particle LET, particle trajectory, drain source voltage]. For each set of values for these parameters this model gives the transient current pulse Itr as a function of time. Then we can represent this model as a function which includes the above parameters plus the time: Itr=fst[t, struck transistor width, particle LET, particle trajectory, Vst], where fst states for fnt for an n struck transistor and for fpt for a p struck transistor, and Vst states for the drain-source voltage of the struck transistor.

For a given inverter (known n and p transistors' width, Vdd level and Cout), and for a particle with given LET trajectory that strikes the n transistor, this model will provide the function Itr=fₙₜ(t, V). Then, to determine the response of the inverter (transient current pulse and/or transient voltage pulse) we have to use the computations described earlier. The output response for particles striking the p transistor is obtained similarly.

This first transient pulse model is convenient when we have to evaluate the response of a moderate number of cells. When we have to evaluate the sensitivity to particle strikes of a complex circuit, which includes large numbers of cells, it may require excessive time for performing the above computations (computation by SPICE of Ip=fₚ(V−Vdd) and then computation of Vtr=fᵥₜᵣ(t) and/or Itr=fᵢₜᵣ(t) for each cell and for each LET level and particle trajectory. The second model is more appropriate for this situation. This second model has as parameters [struck transistor width, non-struck transistor width, particle LET, particle trajectory, Vdd, Cout]. We can compute the voltage transient pulse Vtr=fᵥₜᵣ(t) and/or the current transient pulse Itr=fᵢₜᵣ(t), for any values of these parameters by employing the method described above. Because we have already created the model for Itr=fst[t, struck transistor width, particle LET, particle trajectory, Vst], this computation does not require any more device simulations. The computation is therefore fast and we can obtain the transient voltage pulse Vtr and/or the transient current pulse Itr for large numbers of instances for the parameters [struck transistor width, non-struck transistor width, particle LET, particle trajectory, Vdd, Cout]. Therefore, creating the second model by means of the first model reduces by 2 the number of parameters used in device simulations.

Method for Reducing the Number of Cell Types Considered in the Model Generation Process

The above method requires generating a transient current pulse model for each type of cell. Because cell libraries used in IC designs include many different cell types, a time-consuming model-generation process is normally required to model all types. To simplify this process, the present invention employs a method consisting of creating the transient current pulse model only for the inverter and afterwards, using the inverter model for determining the transient current pulse created by a particle striking a transistor of other cells, such as storage cells or complex gates (SRAM, NAND, NOR, TRISTATE, . . . ). For easy reference these cells will be referred to hereafter as complex cells. In particular, for a particle striking a transistor of this cell, we determine the size of the transistors and the output capacitance of an inverter (to be referred to as the equivalent inverter) in which the particle strike will induce a similar transient current pulse as in the complex cell. Then we use the inverter model to determine the transient current pulse induced in the equivalent inverter, and we obtain as a result, the transient current pulse induced by the particle striking the transistor of the complex cell.

To describe this method, let us consider as example the NOR gate in FIG. 6, consisting of transistor P1 of p type having its source connected to the Vdd power rail, transistor P2 of p type having its source connected to the drain of transistor P1 and its drain connected to the output line Out, transistor N1 of n type having its source connected to the ground rail and its drain connected to the output line Out of the gate, and transistor N2 of n type having its source connected to the ground rail and its drain connected to the output line Out. The gates of transistors N1 and P1 are connected to the input line IN1 and the gates of transistors N2 and P2 are connected to the input line IN2. The output line Out (603) drives some other cells (not shown in the figure) resulting to a load capacitance Cout (604) connected to the output line Out (603). Consider the case where both inputs IN1 (601) and IN2 (602) are at the logic value 1 and a particle strikes the drain of the transistor P2. Transistor P2 is in the OFF state due to the logic level 1 applied on the input line IN2. The transient current pulse created by the particle strike will be injected on the output line Out (603), since the drain of transistor P2 is connected to this line. We can determine the injected current by constructing an inverter, which will collect a similar transient current pulse. This inverter is shown in FIG. 7.

Referring to FIG. 7, the inverter consists of a p type transistor Peq (701) connected between the power rail Vdd (702) and the output line Oeq (703), and a n type transistor Neq (704) connected between the ground rail and the output line Oeq (703). The gates of transistors Neq and Peq are connected on the input line IN (705). The output capacitance of the inverter (capacitance of Oeq) is Ceq (706). The input line IN of the inverter is in the logic state 1. The particle strikes the drain of transistor Peq of the inverter. Thus, the transient current pulse is injected on the output line Oeq of the inverter. To observe the same transient current pulse in both cases, the electrical characteristics of the circuitry that conditions the shape and amplitude of the transient current pulse, should be equivalent in the two cases. Thus, Peq will be of the same size as P2, to have the same charge collection efficiency as P2. This is not enough because the charge collection efficiency is also conditioned by the voltage level of the struck drain. This voltage is determined by the transient current pulse itself, by the capacitance charged (or discharged if the struck transistor was of n type) by this current pulse, and by the current driven by the transistor network which discharge this capacitance (or charge this capacitance if the struck transistor was of n type). Thus, for the case of a particle striking the transistor P2 of the NOR gate of FIG. 6, the capacitance Ceq (706 in FIG. 7) will have the same value as Cout (604 in FIG. 6). The size of transistor Neq will be selected to drive the same current as the parallel connection of transistors N1 and N2. For instance, if transistors Neq, N1 and N2 have the same length, which is generally the case in cell library cells, then, the width Weq of Neq will be selected equal to W1+W2, with W1 the width of N1 and W2 the width of N2.

As another example illustrating the use of a simple gate producing the similar transient current pulse as the complex gate struck by a particle, let us refer again to FIGS. 6 and 7 and consider the case where the input line IN1 of the NOR gate (601) is at the logic 1 level and the input line In2 (602) is at the logic 0 level. Let us also consider that the particle strikes the drain of P1. In this case, the transient current pulse will be injected on the node ND1, which is connected to the output line of the complex gate Out (603) through the transistor P2.

A simplified method yielding results of good precision, consists on using as equivalent gate to the NOR gate, an inverter in which Peq has the same size as P1, Ceq has the same value as Cout, and the size of Neq is determined by the following steps:
connecting on the drain of the struck transistor (drain of P1 in the present case), a voltage source providing a fixed voltage, preferably a voltage V equal or slightly higher to the voltage of the Vdd power rail;
determining the current I_{dc} which flows from this source to the transistor network of the gate;
determining the size of Neq as the size of a n-type transistor for which a current equal to I_{dc} flows through this transistor when its gate is at the logic 1 level and its drain-source voltage is equal to V.

Note that in the above computation of the size of Neq, we used a voltage V equal or slightly higher to Vdd because the voltage of the struck drain is slightly higher than Vdd for the largest part of the charge collection phase. By comparing results obtained with this method against results obtained through mixed-mode 3D-device simulations for numerous practical cases (cells used in standard cell libraries and particles with energies encountered in terrestrial and space environments), we found this method to give results of good accuracy.

Also, this method reduces drastically the process of transient pulse model generation, as it requires developing the model only for the inverter. However, this method is overly simplistic because, in this formulation, the transient current pulse has to flow through transistor P2 to charge the output capacitance Cout. Thus, to obtain highly accurate results we have on the one hand to consider an RC load (RC circuit composed of the resistance of transistor P2 and the output capacitance Cout). On the other hand as p-type and n-type transistors have quite different drain-source current (Ids) characteristics, it is not possible to determine a transistor of n type (transistor Neq), which has similar Ids characteristics for all realistic values of drain source voltages (Vds) as a transistor network which includes both p-type and n-type transistors. Thus, to obtain very accurate results for particles striking a transistor that is not connected to the output of the struck gate, we will generate the current pulse model for a circuit (to be mentioned hereafter as “equivalent circuit”) more complex than the inverter. For the case where the particle strikes a p-type transistor, we will use an equivalent circuit shown in FIG. 8.

Referring now to FIG. 8, this circuit consists of a p-type transistor P1eq (801) having its source connected to the Vdd power rail, a p-type transistor P2eq (802) having its source connected to the drain of transistor P1eq and its drain connected to the output line Oeq (803), and a n-type transistor Neq (804) having its source connected to the ground rail and its drain connected to the output line Oeq. The gates of transistors P1eq and Neq are connected to the input line IN1eq (805) and the gate of transistor P2eq is connected to the input line IN2eq (806). The capacitance of the output line Oeq is Ceq (807). The model will be generated for the transient current pulse induced by a particle striking transistor P1eq, when IN1eq is at the logic value 1 (hence P1eq will be OFF and Neq ON) and IN2eq is at the logic value 0 (P2eq will be ON). Then, we can use this model to determine the transient current pulse for a particle striking a p-type transistor of a complex gate. To determine this current pulse we have to determine the size of transistors P1eq (801), P2eq (802) and Neq (804) and the value of capacitance Ceq (807) in the gate of FIG. 8, which give the similar transient current pulse as the one induced into the complex gate. These parameters are determined in the following manner:
The size of P1eq is equal to the size of the struck p-type transistor of the complex gate. This struck transistor will be referred hereafter as Pstr.
The size of transistor P2eq is determined such that the current flowing though this transistor when we apply the logic 0 value on its gate, any voltage value V, between its source and the logic drain, to drive the same current as the network of ON p-type transistors connecting the drain of transistor Pstr to the output of the complex gate, under the same polarization conditions.
The size of Neq is determined to drive the same current as the network of ON n-type transistors connecting the output of the complex gate to the ground rail.
The capacitance Ceq is equal to the output capacitance of the complex gate.

To determine the current pulse for particles striking the n-type transistors of complex gates we will employ the “equivalent circuit” of FIG. 9. This circuit consists of transistor N1eq (902) of n type having its source connected to the ground rail, transistor N2eq (904) of n type having its source connected to the drain of transistor N1eq and its drain connected to the output line Oeq (906), and a transistor Peq (908) of p type having its source connected to the Vdd power rail (910) and its drain connected to the output line Oeq (906). The gates of transistors N1eq and Peq are connected to the input line IN1eq (912) and the gate of transistor N2eq (904) is connected to the input line IN2eq (914). The capacitance of the output line Oeq is Ceq (916). The model will be generated for the transient current pulse induced by a particle striking transistor N1eq, when IN1eq is on the logic value 0 (N1eq is OFF and Peq is ON) and IN2eq is on the logic value 1 (N2eq is ON). Then, to use this model to determine the transient current pulse induced by a particle striking a n-type transistor of a complex gate we will determine the size of transistors N1eq (902), N2eq (904) and Peq (908) and the value of capacitance Ceq (916) of the circuit of FIG. 9 in the following manner:
The size of N1eq is equal to the size of the struck n-type transistor of the complex gate. This transistor will be referred hereafter as Nstr.
The size of N2eq is determined to drive the same current as the network of ON n-type transistors connecting the drain of transistor Nstr to the output of the complex gate, under the same polarization conditions.
The size of Peq is determined to drive the same current as the network of ON p-type transistors connecting the output of the complex gate to the Vdd power rail.
The capacitance Ceq is equal to the output capacitance of the complex gate.

To reduce the model complexity, we can use as in the case of the inverter, the parameter reduction methods described earlier. In particular, for the method reducing the number of circuit parameters we have two reduction models. The first reduction model uses only the polarization of the struck transistor (drain-source voltage) as circuit parameter. This first reduction model is identical to the model used for the inverter, since it involves only the struck transistor. As in the case of the inverter, this first reduction model can be used to reduce the number of device simulations necessary for creating the second reduction model. The computations needed to create the data required for the second reduction model can be illustrated by referring to FIG. 9. Inputs values are IN1eq=gnd, IN2eq=Vdd. The struck transistor is N1eq. Let V be the voltage of output node Oeq and V1 be the voltage of node ND1. The drain-source voltage of N1eq is V1. The drain source voltage of N2eq is V−V1 and the drain source voltage of Peq is V−Vdd. Let Itr be the current flowing through N1eq, let Inds be the current flowing through N2eq, let Ipds be the current flowing through Peq and let Ic be the current discharging the output capacitance Ceq. The first reduction model will give Itr as a function of time and of drain-source voltage V1 of N1eq, as Itr=fₙ₁ₜ(t, V1). The transfer characteristics of N2eq and Peq give the functions In2ds=fₙ₂(V−V1), and Ipds=fₚ(V−Vdd). At any time t we will have Itr(t)=In2ds(t) and Itr(t)=Ipds(t)+Ic(t), where Ipds is the current flowing through Peq and Ic the current discharging the output capacitance Ceq. These relations give the equations fₙ₁ₜ(tᵢ, V1(tᵢ))=fₙ₂(V(tᵢ)−V1 (tᵢ)) and fₙ₁ₜ(tᵢ, V1(tᵢ))=fₚ(V(tᵢ)−Vdd)−Ceq(V(tᵢ)−V(tᵢ₊₁))/(tᵢ−tᵢ₊₁). If we know V1(tᵢ) and V(tᵢ) at time tᵢ, we can from the second equation obtain V(tᵢ₊₁) at time tᵢ₊₁. Then, knowing V(tᵢ₊₁) we can resolve numerically the equation fₙ₁ₜ(tᵢ₊₁, V1(tᵢ₊₁))=fₙ₂(V(tᵢ₊₁)−V1(tᵢ₊₁)) to determine V1(tᵢ₊₁). We start from the instant t₀ where we have V1(t₀)=V(t₀)=Vdd (value of V1 and V before they are affected by the particle strike). From these values we determine V(t₁) and V1(t₁) at instant t₁. Then, from these values we determine V(t₂) and V1(t₂) at instant t₂, and so on.

The set of parameters of the TCAD model may also depend on the context in which the model will be used, such as in an aerospace environment, or in a heavy ion or neutron only environment. For instance:
The standard TCAD model is used to qualify a target technological process. In this case, the process parameters are fixed when performing the simulations used to create the TCAD model, and the TCAD model parameters are the parameters describing the size of the struck transistor, the characteristics of the circuit surrounding this transistor, the characteristics of the ionizing particle and of its trajectory. The number of these parameters could eventually be reduced as described above.
To enable the user to determine the most suitable values for a set of parameters of the technological process leading to reduced circuit sensitivity with respect to SEUs or SETs, this set of parameters will be variable during the simulations used to created the TCAD model and the parameters of the TCAD model will include this set of process parameters in addition to the parameters describing the size of the struck transistor, the characteristics of the circuit surrounding this transistor, and the characteristics of the ionizing particle and of its trajectory. In modern technologies, process parameters are affected by significant statistical variations. This kind of TCAD model will also be used to determine the impact of these variations on the transient current pulse and on circuit sensitivity phase to ionizing particles.
Because the number of parameters used in the later TCAD model is higher than in the former one, the complexity of the process of TCAD model generation and particularly the number of simulations required to create it is higher. To reduce this complexity, a cell model corresponding to a given cell (e.g. a given memory cell) can be developed. In this case, the size of the struck transistor and the characteristics of the surrounding circuit are fixed during the simulations. Thus, the inputs of the cell model will include the target parameters of the technological process, the parameters describing the ionizing particle and the parameters describing its trajectory, but neither the size of the struck transistor nor the parameters of the circuit surrounding this transistor. This kind of cell model can be developed for a few selected cells and be employed by designers to determine the impact of process parameter changes on cell sensitivity.

Using the kind of models described above, designers can select the values of the process parameters that best fit their requirements in terms of SEU and SET sensitivity. They can also estimate the impact of process parameters variations intrinsic to nanometric technologies.

With these parameter reduction methods and simplification considerations and constraints in mind, exemplary forms of the invention method and tool are now described.

An Exemplary Description of the Present Invention

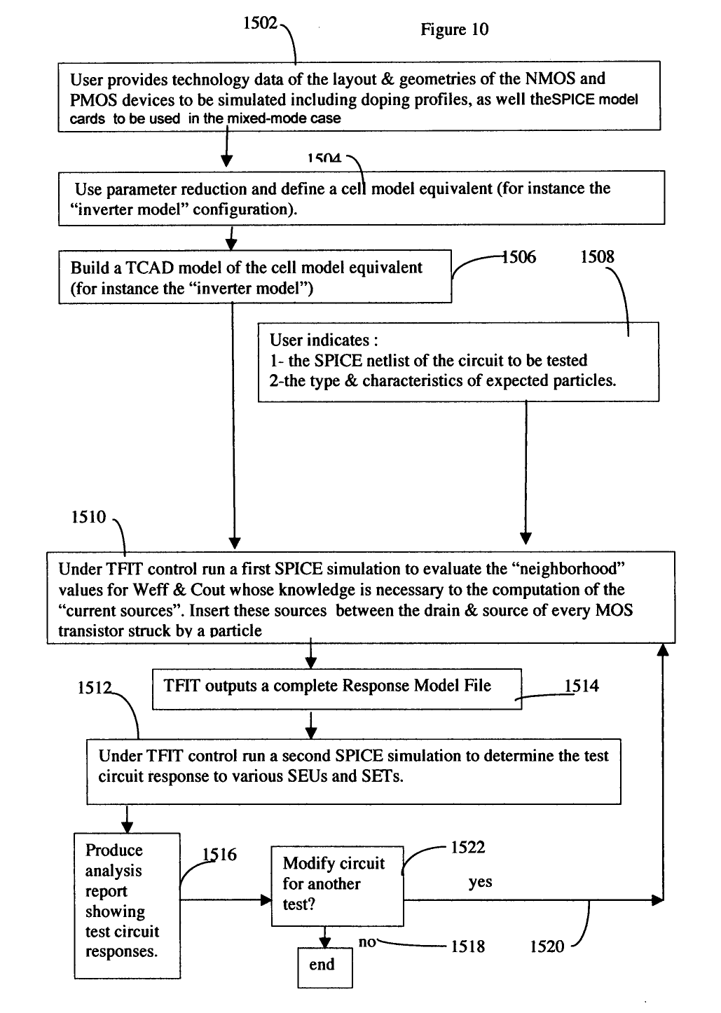

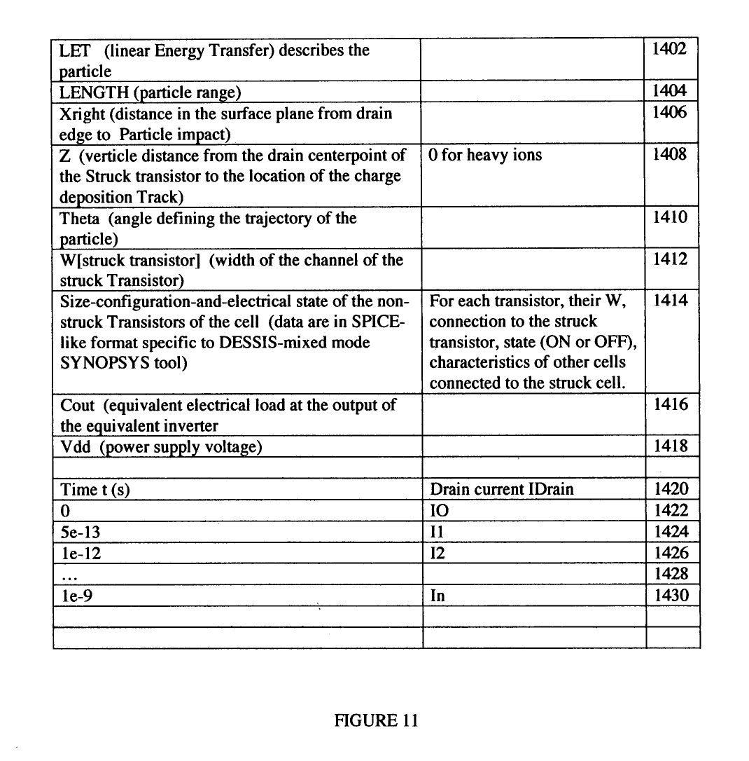

Referring now to FIG. 10, an exemplary embodiment of the method of the present invention is described. Initially, the details of a design of a target cell or circuit, a configuration for which we desire to analyze the behavior to SEUs and SETs, is provided. (1502). The User provides technology data of the layout & geometries of the NMOS and PMOS devices to be simulated including doping profiles, as well the SPICE model cards to be used in the mixed-mode case. A description of each element of the cell or circuit is made by using the full SPICE netlist of the circuit, which includes the entire set of device connectivities as well as the SPICE model cards to be used. Parameter reduction methods, similar to those described above as well as a cell model equivalent are to be defined (1504).

A TCAD model of the cell model equivalent has to be built at first (1506). For the technology data (doping profiles, layout and geometries of the NMOS and PMOS devices to be simulated) different types of formats can be used to build the 3D TCAD structures. In an exemplary embodiment the preferred ones are:
Tsuprem4 files with STR or TIFF format;
DIOS or FLOOPS files can also be employed, using their own DF-ISE format (.grd and .dat files);
To a lesser extent, we can also use a set of 1D sections of doping profiles for the NMOS and PMOS parts to build manually the 3D doping distribution.

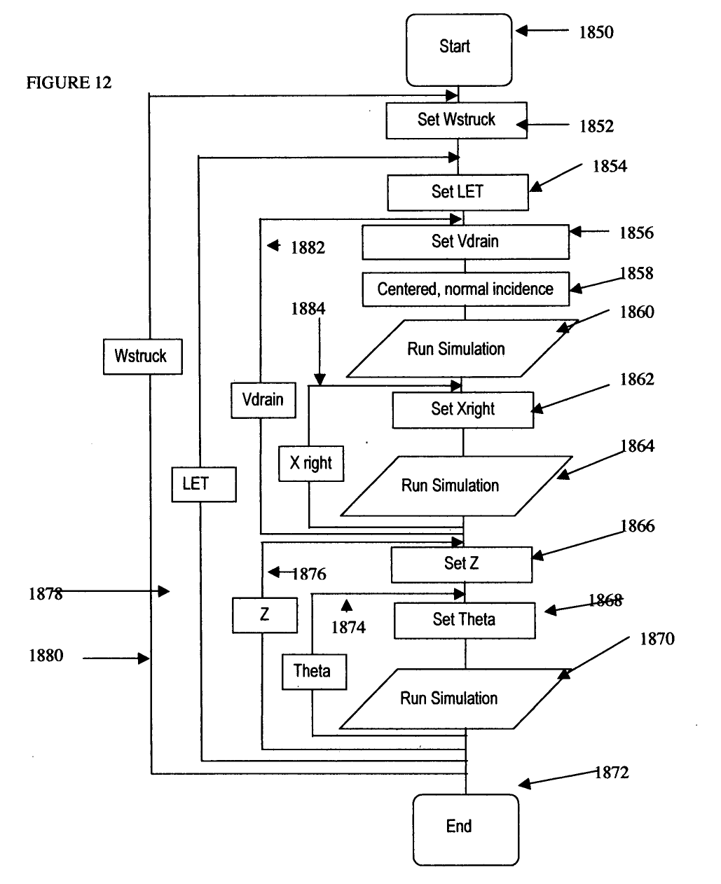

In an exemplary embodiment, the above data is used to create a TCAD model of the technological node (which the target test cell or circuit refers to) using the methods of parameter reduction and the 3D simulation approach described above. For instance, the TCAD model may have been simply generated by only using an inverter cell together with its output capacitive load Cout, where the struck OFF MOS transistor is simulated in 3D, the ON MOS transistor as well as Cout are described at the SPICE level (3D mixed-mode device simulation). The additional processing to build the TCAD model from the above data is described with respect to FIG. 12 in more detail below.

For example, in a preferred embodiment, an exemplary cell based on two inverters, whose TFIT simulation is desired, would look like the following (SPICE format):

*TEST 1: 2 small INVERTERS
.include Bsim3.sp
.SUBCKT INVDL A Z VDD VSS
M2 Z A VSS VSS n W=1.030U L=0.185U
+ AD=0.419P AS=0.743P PD=1.840U PS=3.600U
+ NRD=0.267 NRS=1.936
M1 Z A VDD VDD p W=1.362U L=0.185U
+ AD=0.531P AS=1.264P PD=2.130U PS=5.490U
+ NRD=0.276 NRS=3.663
C3 A VSS 0.326ff
C4 Z VSS 0.137ff
C3_{—}4 A Z 0.091ff
.ENDS INVDL
X1 A B VDD VSS INVDL
X2 B C VDD VSS INVDL

Returning to FIG. 10, the TCAD model (1506) and other User data (1508) are now passed to TFIT control for a first SPICE simulation run (1510). A description of the environment (aerospace application, nuclear plant application, etc.) is provided, by using the TFIT configuration file, to indicate the type and the characteristics of particles expected (neutrons, heavy ions, etc.). Also provided—in the case of neutron impact—is a database of particles which contain especially for each secondary particle type, the LET and Range data for the particle. In the current best mode, a particle database used is licensed from the CEA, which is the “Commissariat a l'Energie Atomique” or the French Atomic Energy Commission. It is a French Government funded research group. See http://www.cea.fr/english_portal

### The particle database file is a table with different columns and rows, each row describing one byproduct particle of collision between neutrons of various energies and Si or O atoms.

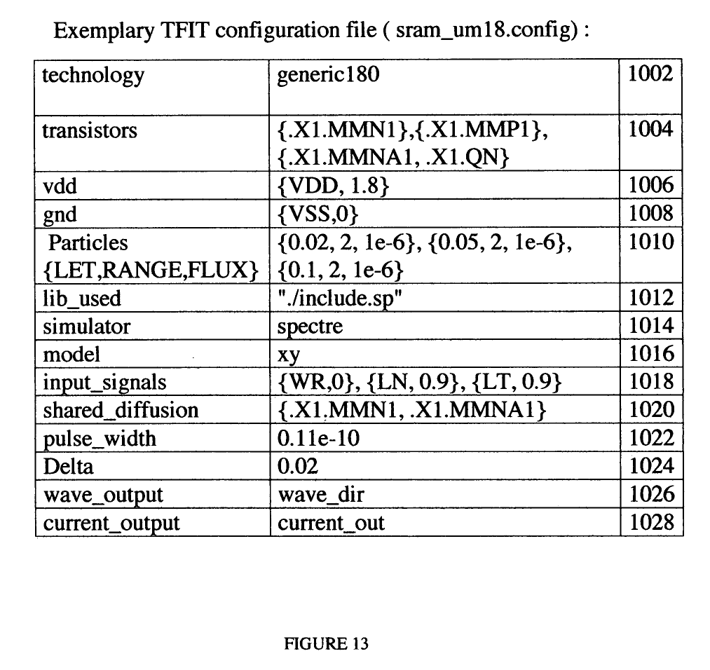

The initial input to the TFIT engine is supplied by a TFIT configuration file (1508). An exemplary embodiment of this configuration file input is shown in FIG. 13. Referring to FIG. 13, an exemplary TFIT Configuration File for a heavy ion impact on an SRAM is shown and described as follows:
technology=generic180 (1002) The TCAD model to be used (corresponding to the given technological node) is defined here.
transistors={.X1.MMN1}, {.X1.MMP1}, {.X1.MMNA1, .X1.QN} (1004) This defines the list of struck transistors (using the SPICE syntax).
vdd={VDD, 1.8} (1006) The value of the power supply (which could be a input parameter of the TCAD model) is specified.
gnd={VSS,0} (1008) This defines the ground value.
particles={0.02, 2, 1e-}, {0.05, 2, 1e-}, {0.1, 2, 1e-} (1010) A set of ionizing particle strikes is defined using the syntax: {LET,RANGE,FLUX}.
lib_used=“./include.sp” (1012) The location of the SPICE model cards.
simulator=spectre (1014) The SPICE simulator to be used.
model=xy (1016) The TFIT mode to be simulated (xy means computation of the DX—or sensitive surface—for heavy ions).
input_signals={WR,0}, {LN, 0.9}, {LT, 0.9} (1018) In the case of SRAM cells, values of the Read/write signals.
shared_diffusion={.X1.MMN1, X1.MMNA1} (1020) list of the transistors who share active diffusion areas
pulse_width=0.11e-10 (1022) This value could be used in the case of SET characterization (ie combinational logic) to allow to build a “quasi logic switching criteria”.
delta=0.02 (1024) In the case of SRAM, the DX value (used to measure the sensitive surface) is computed using half this accuracy (0.01 um).
wave_output=wave_dir (1026) The output voltages of the struck transistors and of their neighborhood are stored in this directory (they can be visualized using alien tool, such as Wavescan from Cadence, Inspect-Synopis, gnuplot, . . . ).
current_output=current_out (1028) THE CURRENT SOURCES ARE STORED in this file in PWL format (one current source is stored for each particle impact and each struck transistor).

Returning now to FIG. 10, in step 1510 the right TCAD model is invoked using the specifications provided by the user within the TFIT configuration file, allowing the creation of the appropriate Response Model File (1514). This means that the TCAD model library to be used is specifically mentioned by the user in the right corresponding field of the TFIT configuration file. Using the various inputs provided with the TCAD data to the TFIT engine, a first SPICE simulation is run. (1510).

In this first SPICE run, A TCAD model of the technological node (which the target test cell or circuit refers to) is expected to have already been developed using the methods of parameter reduction and 3D simulation method described above. (1506). For instance, the TCAD model may have been simply generated by only using an inverter cell together with its output capacitive load Cout, where the struck OFF MOS transistor is simulated in 3D, the ON MOS transistor as well as Cout are described at the SPICE level (3D mixed-mode device simulation). Preliminary circuit simulations are run by TFIT to extract the so-called “neighborhood” information, namely: Weff (the size of the equivalent ON MOS transistor when the TCAD model has been built by using the inverter configuration described above), and Cout (the equivalent output capacitance still in the case where the inverter cell has been used to create the TCAD model). In this first SPICE simulation run, based on the previous analysis of the target test cell or circuit, the TFIT engine inserts into the cell or circuit, several pseudo elements called “current sources” to represent the results of one or several particles striking one or several MOS devices usually polarized in the OFF state. A current source is connected by TFIT between the drain and the source of every MOS transistor struck by an ionizing particle, getting TFIT to modify “internally” the initial SPICE netlist to meet this goal. This method allows the system to describe, at the cell or circuit levels, the effects of assumed SEU or SET. Finally, this first SPICE run is dedicated to computing the Weff and Ceff (Ceff is the equivalent capacitance in the struck node) values for each new simulated cell or circuit. These Weff and Ceff values represent the effects of the circuit environment of the struck transistor corresponding to the “inverter model.”

The data for the response model file (that is to say the specification of the various current sources to be applied to the cell or circuit nodes struck by a ionizing particle) are generated in this first SPICE simulation run and are shown in an exemplary embodiment in the data structure of FIG. 11.

As indicated, these data are the primary output of the first SPICE simulation run by the TFIT engine, designated the Response Model File (1514) and becomes the primary input to the second SPICE simulation run under the control of the TFIT engine. (1512). The second SPICE run is designed to compute either:
the FIT of a cell, particularly of SRAMs (in the neutron particle mode) (this task generally takes less than 10 nm); or
the cross-sections curves (versus LET) of cells (especially SRAMs) in 2D (or heavy ion mode) (this task generally takes less than 1 nm).

Various designated circuit analysis cases can be run quickly but these 2 SPICE runs (1510 and 1512), which correspond to one single TFIT run, are systematically run sequentially, each time TFIT is invoked (even when the simulated cell/circuit has not be modified).

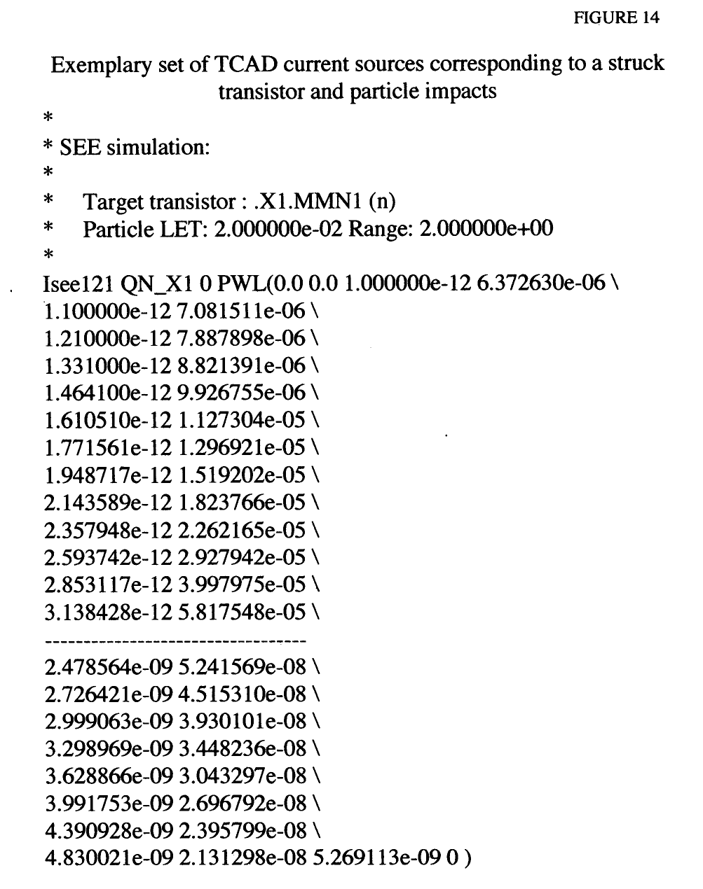

In case of neutrons impact, the preprocessing engine, incorporated within TFIT, is used to create the complete set of secondary particles, and the FIT [“Failure in time” rate] is computed after the full set of SPICE simulations is carried out. In this later case, the TFIT controller produces a specific engine devoted to build, for each LET value, a sensitive volume surrounding the drain region in order to classify more easily the set of secondary particles and get the FIT to be computed simpler and faster. The results of this latter simulation are produced in an analysis report showing the test circuit response to the assumed SEUs and SETs. (1516). Exemplary TFIT output reports are shown in FIGS. 14, 15 and 16.

Finally, a modification to the target test cell or circuit can be performed (1522), wherein the modified target test cell or circuit is expected to be immune from malfunctions due to SEU or SET, the user being advised to rerun TFIT to make sure this goal has been achieved. Alternatively, the user can use the TFIT tool to run various cases such as for example:
Case 1: The user may select one particle, one impact point and one trajectory and obtain the SEU or SET responses for various W values for every struck transistor of the target cell. Or
Case 2: The user may select say n heavy ions, impact points and trajectories and obtain the responses for different W values for each trajectory, and impact point, for each different ion.
   In the exemplary embodiments explored by applicants the current source insertion method used various exemplary methods. In the case of inverter and in many cases simulated, the bulk node and the source node of the struck transistor were wired together and the current source was inserted between the drain and source. But in more complex cases, these 2 nodes are separated and the current source must be inserted between the drain and the bulk. So, in a general exemplary embodiment, the current source is inserted between the drain and the bulk. Additionally, it should be noted that in other embodiments the diffusion struck by the particle can also be the source (depending on the chosen convention), in which case it could be said that the current source is inserted between the diffusion affected by the strike and the bulk. Thus in the definition section above, applicants indicate that when the drain is the diffusion area struck by a ionizing particle, it could be either a DRAIN or a SOURCE depending on the studied cell configuration.

Developing the Basic TCAD Model (Basic Technology Database File)

Since the set of TCAD models (or technology database) forms the basis for the TFIT/SPICE simulations to develop the expected SEU and SET effects of a particle strike, we now describe in more details the generation of certain data fields in the TCAD (technology) database in step 1506 of FIG. 10 using as reference FIG. 12. FIG. 12 describes the “strategy” used to create the TCAD model using the 3D mixed-mode simulation approach (thanks to Synopsys TCAD suite). Referring now to FIG. 12 an iteration process is described for each struck transistor, wherein current values caused by a particle strike are calculated for various angles of θ (angle defining the trajectory of the particle) (1868, 1870 and 1874), within various values of Z (vertical distance from the drain centerpoint of the Struck transistor to the location of the charge deposition Track) (1866 and 1876). In the case where the parameter reduction method is used for these 2 parameters (Z and θ), only a limited number of their values are simulated in order to validate the hypothesis relating to the reduction method. Correlatively, an outer iteration process is used for various values of Xright (distance in the surface plane from drain edge to Particle impact) (1862, 1864 and 1884), and for various values of Vdrain (1856, 1858, 1860 and 1882) (Vdrain being either VDD, the power supply, in the general case OR the potential applied on the drain of the single MOS transistor in the case of the first or second reduction model), within various values of LET (linear Energy Transfer) for the particle (1854 and 1878), as related to the various values of W[struck transistor] (width of the channel of the struck Transistor) (1852 and 1880).

Initially (1852) the Wstruck value (width of the channel of the struck Transistor) is set for the first Transistor. Then the first LET value of the first particle is set (1854). A value for Vdrain is set (1856) followed by settings to indicate the particle path location in the drain (1858). After these settings are made, a 3D TCAD simulation is run (1860) to establish the TCAD model. This simulation is followed by an initial setting for Xright (1862) and a 3D TCAD simulation is run (1864). At this point Xright (the distance in the surface plane from drain-edge to particle-impact) is incremented by steps of 0.05 to 0.1 um, depending on the TCAD model accuracy which one desires to achieve, and the 3D simulation is run again. This iteration on various values of Xright continues until practical values for Xright are exhausted, which means in practice that the particle strike does not perturb anymore the simulated cell (usually an inverter). Upon completion of this iteration on values of Xright, the value of Vdrain is incremented from VD to VDD+VD (VDD being the value of the power supply, and VD=0.7V being the potential of the forward-bias diode), by a step of 0.2 to 0.3V (10 values are usually sufficient to build a model of a good accuracy)(1882); the simulation on this new value of Vdrain (1860) is repeated and the iteration on all values of Xright processed again (1862, 1864 and 1884). This iteration over various values of Vdrain (1882) continues until practical values for Vdrain are exhausted.

At this stage in the iteration of values in FIG. 12, the system has calculated and stored values of the current collected by the drain of the struck transistor. The next set of calculations involves iterating on various values of the particle trajectory (theta) within various values of the vertical distance from the drain centerpoint of the Struck transistor to the location of the charge deposition Track (Z). In this case, an initial value of Z is set (1866) and an initial value of q is set (1868). Yet another simulation is run (1870) to calculate the drain current and this value used to validate the assumptions of the parameter reduction method in case it is used. The value of θ is incremented by 15 degrees each iteration (1874) (basically θ has values of: 0, 15, 30, 45, 60, 75, 90, but also: −15, −30, −45, −60, −75, −90). On completion of the iterations over all values of θ, Z is incremented by steps of 005 to 0.1 um, depending on the TCAD model accuracy which one desires to achieve, (1876) and the iteration over all values of θ is performed once again (1868, 1870 and 1874). When the parameter reduction method is used, these 2 numbers of steps (for Z and θ) are obviously limited to only a few points designed to validate the hypothesis. When calculations of the drain current have been made for all values of Z (1878), the value for the LET (linear Energy Transfer) of the particle is incremented to the next particle value (a number of simulated LET of around 10, within the range [0, 0.16] pC/um, are enough to create an accurate TCAD model for neutrons), and the iterative calculations just described are repeated for all defined particles. At that time the entire iterative process is repeated for the next struck transistor designated (1880). Upon completion of all calculations for all designated transistors and particles, the TCAD model, which relates the current source to the entire set of input parameters, can be built using the techniques described above.

An Exemplary Output

Exemplary outputs from the TFIT SPICE runs are shown in FIGS. 14, 15 and 16. In FIG. 14 a partial listing of a TFIT report shows TCAD current source corresponding to a struck transistor and particle impact. In this Figure the left hand column represents values of time and the right hand column represents corresponding values of the current. A plot of these values would depict the current response curve expressing a particle strike.

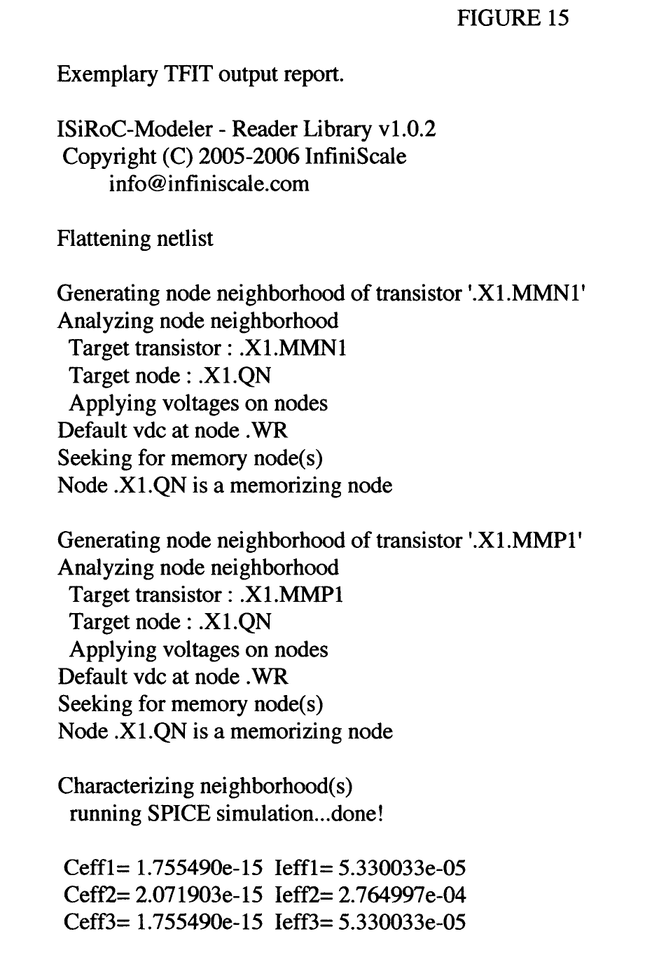

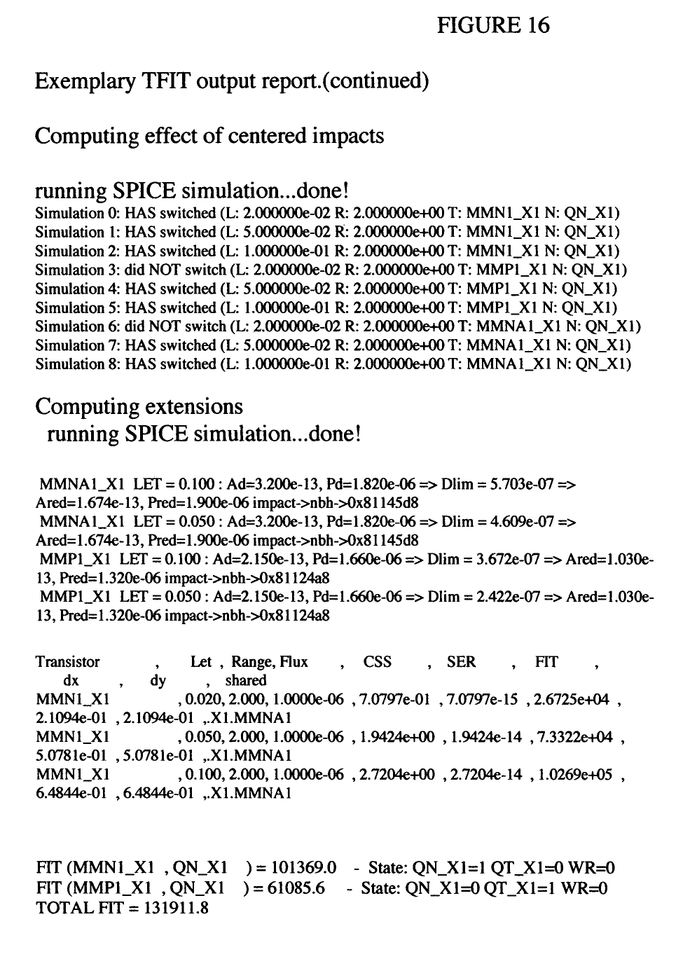

Referring now to FIGS. 15 and 16, this represents an exemplary output for the “file sram_xy_result”. This is the output report (or tty output) written by TFIT. In FIG. 15 it is evident that a first SPICE simulation is run, for each struck transistor, in order to compute the neighborhood information, namely: Ceff and Ieff (leff being an equivalent of Weff). Afterwards, as shown in FIG. 16, a centered impact is simulated, and finally the distance from the drain DX above which the SRAM does not switch anymore is computed (for each struck transistor). This value allows one thereafter, to estimate the sensitive surface, as well as the cross-sections of each transistor constituting the SRAM.

Making use of the mathematical models of the target circuits described above, in order to make the kind and number of the model simulations tractable within given cost and time constraints, the present invention is also claimed as an apparatus, a computer system making use of a TCAD model produced as described above, and a tool, designated TFIT, or equivalent for computational purposes for producing response model files and data for use in cell and circuit analysis of SEU and SET events.

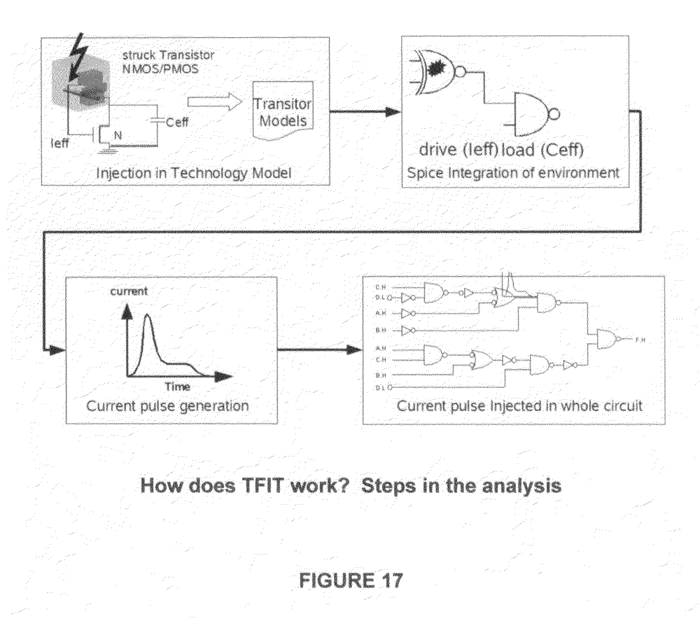

Finally in summary, FIG. 17 shows pictorially the major functional steps performed by TFIT. Those skilled in these arts may find various alternative embodiments of these functions to produce similar results without deviating from the intent and contents of the present invention as described herein.

We claim:

1. A computer implemented method for determining the effect on a target test cell or circuit when one or more ionizing particles strike a region surrounding a drain of one or more transistors (the struck transistor) in an integrated circuit, the method comprising the acts of:
providing technology data of layout and geometries of two transistors (NMOS-PMOS) to be modeled, including doping profiles and SPICE model cards;
providing a description, by element, of the target test cell or circuit, the description (Spice netlist) comprising transistors (NMOS and PMOS) belonging (among others, but not being limited) to such cells as inverters, NOR and NAND gates, SRAMs, TRISTATEs, Flip-flops, Latches;
building a TCAD model (for both the NMOS and the P-MOS transistors) relating to a cell equivalent (usually an inverter) defined for the target test cell or circuit;
providing in the TCAD model, an element called “current source” to represent an ionizing particle perturbation;
placing the current source element between the drain and a bulk of a struck transistor;
including in the TCAD model, a configuration and electrical states of non struck transistors of the target test cell or circuit to characterize the response of the struck transistor;
including in the TCAD model, characteristics of transistors and cells surrounding the struck transistor, to characterize the response of the struck transistor;
Including as inputs to a TFIT interface program tool, a definition of an ionizing environment of interest, which, if the ionizing environment of interest is a light or heavy ion environment, includes characteristics of the ionizing particle comprising the particle's LET, ranges, impact locations and angle of incidence, and if the ionizing environment of interest is a neutron environment, includes a pointer to a neutron particle database;
Including as additional inputs to the TFIT interface program tool, Spice characteristics of the transistor struck by the ionizing particle (L,W,As,Ad,Ps,Pd) and Spice characteristics of the circuit surrounding the struck transistor;
Under control of the TFIT interface program tool, determining a value for the current source element from a SPICE simulation of the struck transistor neighborhood, the value representing a transient current pulse induced by an ionizing particle striking a transistor of the target test cell or circuit;
Under control of the TFIT interface program tool, applying the determined value for the current source to the struck node of the target test cell or circuit to determine an effect of a strike by an ionizing particle on the target test cell or circuit, and computing the FIT in a neutron environment, or determining the SET or SER for one or more ionizing particles produced by light or heavy ions; and
producing by the TFIT interface program tool, a report showing the effects on the struck transistors and the target test circuit of a strike by an ionizing particle, to predict behavior of complex MOS gates to SET, as well as the response of SRAM cells to SEU aggressions especially to neutrons.

2. The computer implemented method of claim 1 wherein the ionizing particle is a light or heavy ion, or a set of light or heavy ions.

3. The computer implemented method of claim 1 wherein the ionizing particle is a secondary ionizing particle resulting from a neutron environment.

4. The computer implemented method of claim 1 wherein the cell equivalent used to build the TCAD model is an inverter, and the TCAD model input parameters are size of the struck transistor, size of the non struck transistor and output capacitance of the inverter.

5. The computer implemented method of claim 1 wherein a modified Messenger equation is used as an analytical model describing the transient pulses induced on struck MOS transistors by ionizing particles, which includes an additional term lcst such that

| | |
|---|---|
| a. lcst= 0 | for t < t0 |
| b. lcst= lsat(Spice)[NMOS or PMOS] | for t0 < t < ta |
| c. lcst= lsat . exp(−(t − ta)/tb) | for t > ta |

6. The computer implemented method of claim 1 wherein characteristics of the ionizing particle trajectory are reduced to an equivalent distance deq, which is a function of angles (θ and φ) of the particle trajectory and of the distance d of this trajectory from the drain of the struck transistor.

7. The computer implemented method of claim 1 wherein inputs to the TCAD model include configuration and electrical states of non-struck transistors of the cell or circuit.

8. The computer implemented method of claim 1 wherein the inputs to the TCAD model include characteristics of other transistors and cells connected to the cell or circuit that includes the struck transistor.

9. The computer implemented method of claim 1 wherein the inputs of the TCAD model include capacitance of branches that participate to dissipate the transient current pulse induced by the ionizing particle.

10. The computer implemented method of claim 1 wherein two SPICE runs are made controlled by TFIT, a first SPICE run to compute a set of various current sources to be applied at outputs of struck nodes, and the second SPICE run to compute either FIT (in a neutron environment) or the SET and SER for one or more ionizing particles (in a light or heavy ion environment).

11. The computer implemented method of claim 1 wherein the response of integrated circuit cells with respect to ionizing particles striking one or more transistors of a cell, for which a transient current pulse model is created only for an inverter gate, a transient current pulse induced by a particle striking a P (respectively a N) transistor is obtained from the created model as the transient current pulse of an inverter in which the struck P (respectively N) transistor has the same size as the struck transistor of the complex gate, and wherein the size of the N (respectively P) transistor is equal to the size of an equivalent ON transistor N (respectively P) of the complex gate.

12. An apparatus for determining the effect on a target test circuit or system when an ionizing particle strikes a region surrounding a drain of a transistor in an integrated circuit, the apparatus comprising:
a. A computer system having at least one input device, at least one processor, a memory, at least one output device, and A TFIT interface program tool in the processor of the computer;
b. Means for providing to the computer system, a description, by element, of transistors (NMOS and PMOS) of a target test cell or circuit (Spice netlist), the description comprising (among others, but not limited to) inverters, NOR and NAND gates, SRAMs, TRISTATEs, Flip-flops, Latches;
c. Means for providing to the computer system, technology data of layout and geometries of the transistors to be modeled, including doping profiles and SPICE model cards;
d. Means for providing to the computer system, a TCAD model for the cell equivalent of the target test cell or circuit;
e. Means for providing in the TCAD model, an element called “current source” to represent an ionizing particle perturbation;
f. Means for placing the current source element between the drain and a bulk of a struck transistor;
g. Means for including in the TCAD model, a configuration and electrical states of non struck transistors of the target test cell or circuit to characterize the response of the struck transistor;
h. Means for including in the TCAD model, characteristics of transistors and cells surrounding the struck transistor, to characterize the response of the struck transistor;
i. Means for providing as inputs to a TFIT interface program tool, characteristics of the ionizing particle, characteristics of the ionizing particle trajectory and impact point, size of the transistor struck by the ionizing particle and characteristics (Spice netlist) of the circuit surrounding the struck transistor;
j. Under control of the TFIT interface program tool, the computer system determining a value for the current source pseudo element from a SPICE simulation of the struck transistor neighborhood, the value representing a transient current pulse induced by an ionizing particle striking a transistor of the target test cell or circuit;
k. The TFIT interface program tool causing the computer to apply the determined value for the current source to the struck node of the target test circuit or system to determine an effect of a strike by an ionizing particle on the target test circuit or system; and
l. The computer system, under the control of the TFIT interface program tool, producing a report showing the effects on the struck transistors and the target test circuit of a strike by an ionizing particle, to predict behavior of complex MOS gates to SET, as well as the response of SRAM cells to SEU aggressions especially to neutrons

13. The apparatus of claim 12 wherein the ionizing particle is a light or heavy ion or a set of light or heavy ions, and wherein data is provided specifying a set of particles together with their characteristics such as LETs, ranges, impact locations and angles of incidence.

14. The apparatus of claim 12 wherein the ionizing particle is a secondary ionizing particle resulting from a neutron environment, and wherein TFIT, using a preprocessor engine, creates a set of secondary particles based upon a database of neutron particles.

15. The apparatus of claim 12 wherein the cell equivalent is an inverter, and the TCAD model input parameters are size of the struck transistor, size of the non struck transistor and output capacitance of the inverter.

16. The apparatus of claim 12 wherein a modified Messenger equation is used as an analytical model describing the transient pulses induced on MOS transistors by ionizing particles, which includes an additional lcst such that

| | |
|---|---|
| p. lcst= 0 | for t < t0 |
| q. lcst= lsat(Spice)[NMOS or PMOS] | for t0 < t < ta |
| r. lcst= lsat . exp(−(t − ta)/tb) | for t > ta |

17. The apparatus of claim 12 wherein characteristics of the ionizing particle trajectory are reduced to an equivalent distance deq which is a function of angles (θ and φ) of the particle trajectory and of the distance d of this trajectory from the drain of the struck transistor.

18. A method for characterizing the response of an integrated circuit cell with respect to ionizing particles striking one or more transistors of the cell, comprising the step of generating empirical models describing a transient current pulse induced by an ionizing particle striking a transistor of the cell, wherein said empirical models are generated from the results of a set of simulations that determine the said transient current pulse for a set of particle LETs, particle trajectories and circuit parameter values.

19. A method according to claim 18, where characteristics of the circuit surrounding the struck transistor are taken into account for generating the transient current pulse models.

20. A method according to claim 18, wherein polarization of the struck transistor is taken into account for generating the transient current pulse models.

21. A method according to claim 18, where inputs to the empirical model includes characteristics of the ionizing particle, characteristics of the ionizing particle trajectory, size of the transistor struck by the ionizing particle and characteristics of the circuit surrounding the struck transistor.

22. A method according to claim 18, wherein the inputs of the empirical model include the characteristics of the ionizing particle, characteristics of the ionizing particle trajectory, size of the transistor struck by the ionizing particle and polarization of the struck transistor.

23. A method according to claim 18 where all simulations are performed for fixed process parameters.

24. A method according to claim 18 where inputs of the empirical model include several parameters of a technological process and the simulations are performed for variable process parameters.

25. A method according to claim 18 where a created empirical model produces the transient current pulse itself.

26. A method according to claim 18 where created empirical models produce parameters of an analytical model of the transient current pulse.

27. A method according to claim 26, where the analytical model of the transient current pulse includes a term Icst such that

| | |
|---|---|
| i. lcst= 0 | for t < t0 |
| ii. lcst= lsat(Spice)[NMOS or PMOS] | for t0 < t < ta |
| iii. lcst= lsat . exp(−(t − ta)/tb) | for t > ta |

28. A method according to claim 18 where configuration and electrical states of non-struck transistors of the cell are taken into account for characterizing the response of the integrated circuit cell.

29. A method according to claim 18 where characteristics of other cells connected to the cell which includes the struck transistor are taken into account for characterizing the response of the integrated circuit cell.

30. A method according to claim 29, where inputs of the empirical model include the configuration and the electrical states of the non-struck transistors of the cell.

31. A method according to claims 30, wherein inputs of the empirical model include characteristics of the other cells connected to the cell which includes the struck transistor.

32. A method according to claim 18 where inputs of the empirical model include output capacitance of the cell that includes the struck transistor.

33. A method according to claim 18 where the cell which includes the struck transistor is an inverter and where circuit characteristics used as inputs of the empirical model are size of the struck transistor, size of the non-struck transistor and output capacitance of the inverter.

34. A method according to claim 18 for characterizing a response of a complex cell with respect to ionizing particles striking a p-type (respectively n-type) transistor Pstr (respectively Nstr) of said complex cell, wherein said complex cell comports at least one output line “Out” loaded by an output capacitance “Cout”, and at least a network of p-type transistors connected between said output line “Out” and a “Vdd” power rail, and at least a network of n-type transistors connected between said output line “Out” and a ground rail, comprising the following steps:
a Creating a transient current pulse model for particles striking the p-type transistor Peq (respectively the n-type transistor Neq) of an inverter, wherein said inverter comports a p-type transistor Peq having its source connected to the Vdd power rail and its drain connected to the output line Oeq and a n-type transistor Neq having its source connected to the ground rail and its drain connected to the output line Oeq. Said output line Oeq being loaded by an output capacitance Ceq;
b Allocating to said p-type transistor Peq (respectively said n-type transistor Neq) of said inverter the size of the struck p-type transistor Pstr (respectively of the struck n-type transistor Nstr) of said complex cell;
c Allocating to said n-type transistor Neq (respectively said p-type transistor Peq) of said inverter a size such that when this transistor is ON, its source is connected to the ground rail (respectively to the Vdd power rail), and its drain is connected to a voltage source furnishing a voltage level V, it is traversed by the same current as the current flowing from said voltage source to the transistor network of said complex cell when said voltage source is connected to the drain of the struck p-type (respectively n-type) transistor Pstr (respectively Nstr);
d Allocating to said output capacitance Ceq of said inverter the value of said output capacitance Cout of the complex cell;
e Using said current pulse model to determine the transient current pulse induced by a particle striking said p-type (respectively n-type) transistor of said inverter; and
f Allocating said transient current pulse induced by the particles striking said p-type (respectively n-type) transistor of said inverter as the transient current pulses induced by ionizing particles striking said p-type (respectively n-type) transistor Pstr (respectively Nstr) of said complex cell.

35. A method according to claim 18 for characterizing the response of a complex cell with respect to ionizing particles striking a p-type (n-type) transistor Pstr (Nstr) of the network of p-type (n-type) transistors of the complex cell, wherein said complex cell comports at least one output line Out loaded by an output capacitance Cout, and at least a network of p-type transistors having a first terminal T1p connected to said output line Out and a second terminal T2p connected to the Vdd power rail, and a network of n-type transistors having a first terminal T1n connected to said output line Out and a second terminal T2n connected to the ground rail, comprising the following steps:
a. Creating a transient current pulse model for: A circuit consisting of first p-type (n-type) transistor P1eq (N1eq) having its source connected to the Vdd power rail (ground rail), second p-type (n-type) transistor P2eq (N2eq) having its source connected to the drain of first p-type (n-type) transistor P1eq (N1eq) and its drain connected to the output line Oeq, and n-type (p-type) transistor Neq (Peq) having its source connected to the ground rail (Vdd power rail) and its drain connected to the output line Oeq; The gates of first p-type (n-type) transistors P1eq (N1eq) and of n-type (p-type) transistor Neq (Peq) being connected to first input line IN1eq and the gate of second p-type (n-type) transistor P2eq (N2eq) being connected to second input line IN2eq; Output line Oeq being loaded by an output capacitance Ceq; and particles striking said first p-type (n-type) transistor P1eq (N1eq) of said circuit, when said first input line IN1eq is at the logic value 1 (0) and second input line IN2eq is at the logic value 0 (1);
b. Allocating to said first p-type (n-type) transistor P1eq (N1eq) the size of the struck p-type (n-type) transistor Pstr (Nstr) of said complex cell;
c. Allocating to said second p-type (n-type) transistor P2eq (N2eq) of said circuit a size such that when this transistor is ON and any voltage V is applied between its source and its drain, it is traversed by the same current as the current flowing through the network of ON p-type (n-type) transistors of the complex cell when the same voltage V is applied between the drain of said struck p-type (n-type) transistor Pstr (Nstr) and said second terminal T2p (T2n) of this network;
d. Allocating to said n-type (p-type) transistor Neq (Peq) of said circuit a size such that when this transistor is ON, its source is connected to the ground rail (Vdd power rail), and its drain is connected to any voltage V, it is traversed by the same current as the current flowing through the network of ON n-type (p-type) transistors of the complex cell, when the said first terminal T1n (T1p) of this network is connected to said voltage V and said second terminal T2n (T2p) of this network is connected to the ground rail (Vdd power rail);
e. Allocating to said output capacitance Ceq of said circuit the value of said output capacitance Cout of said complex cell;
f. Using said current pulse model to determine the transient current pulse induced by a particle striking said first p-type (n-type) transistor P1eq (N1eq) of said circuit; and
g. Allocating said transient current pulse induced by the particles striking said first p-type (n-type) transistor P1eq (N1eq) of said circuit as the transient current pulses induced by ionizing particles striking said p-type (n-type) transistor Pstr (Nstr) of said network of p-type (n-type) transistors of said complex cell.

36. A method according to claim 20, where the characteristics of the ionizing particle trajectory are described by an equivalent distance deq which is function of the angles (θ and φ) of the particle trajectory and of the distance d of this trajectory from the drain of the struck transistor.

37. A computer implemented method for determining the effect on a target test cell or circuit when an ionizing particle strikes a region surrounding a drain of a transistor (called “the struck transistor”) in an integrated circuit, the method comprising the acts of:
providing a description, by element, of the target test cell or circuit, including technology data of layout and geometries of transistors to be modeled, including doping profiles, SPICE model cards and SPICE netlists;
providing a TCAD model for the NMOS and PMOS transistors of the cell equivalent used for the target test cell or circuit, including within the TCAD model, a configuration and electrical states of non struck transistors of the target test cell or circuit and characteristics of cells surrounding the struck transistor, to characterize the response of the target test cell or circuit;
providing a TFIT interface program tool (TFIT), and inputs to TFIT including the TCAD model and a definition of an ionizing environment of interest, which, if the ionizing environment of interest is a light or heavy ion environment, includes characteristics of the ionizing particles comprising the particle's LET, ranges, impact locations and angle of incidence, and if the ionizing environment of interest is a neutron environment, includes a pointer to a neutron particle database;
Including as additional inputs to the TFIT interface program, SPICE characteristics of the transistor struck by the ionizing particle and SPICE characteristics of the circuit surrounding the struck transistor;
Under control of the TFIT interface program tool, using an element called “current source” to represent an ionizing particle perturbation, and placing the current source element between the drain and a bulk node of a struck transistor, modifying the SPICE netlists to account for the current source elements inserted,
Under control of the TFIT interface program tool, determining a value for the current source element from a SPICE simulation of the struck transistor neighborhood, the value representing a transient current pulse induced by an ionizing particle striking a transistor of the target test cell or circuit;
Under control of the TFIT interface program tool, applying the determined value for the current source to the struck node of the target test cell or circuit to determine an effect of a strike by an ionizing particle on the target test cell or circuit, and by computing the FIT in a neutron environment, and alternatinely, determining the SET or SER for one or more ionizing particles in a light or heavy ion environment; and
producing by the TFIT interface program tool, a report showing the effects on the struck transistors and the target test circuit of a strike by an ionizing particle, to predict behavior of complex MOS gates to SET, as well as the response of SRAM cells to SEU aggressions.
